(19) United States
(12) Patent Application Publication
(10) Pub. No.: US 2023/0285948 A1
(43) Pub. Date: Sep. 14, 2023

(54) Remote Thermal Activation of Particles for Ingredient Release and Activation

(71) Applicant: Nano Catalytics, Inc., Cincinnati, OH (US)

(72) Inventors: Adam Gregg Malofsky, Loveland, OH (US); Steve Levin, Cincinnati, OH (US); Srinagesh Kumar Potluri, Mason, OH (US); Jane Morris Shafer, Cincinnati, OH (US)

(21) Appl. No.: 18/055,302

(22) Filed: Nov. 14, 2022

Related U.S. Application Data
(60) Provisional application No. 63/278,235, filed on Nov. 11, 2021.

(51) Int. Cl. B01J 35/00; B01J 13/14

(52) U.S. Cl. CPC B01J 35/0013; B01J 35/006; B01J 13/14; C08F 4/02

(57) ABSTRACT

This invention relates to a matrix particle, comprising: (i) a matrix material, wherein said matrix material is capable of fully or partially altering its physical/chemical characteristics; (ii) at least one susceptor component, wherein said at least one susceptor component is embedded in said matrix material; and (iii) at least one releasable ingredient, wherein said at least one releasable ingredient is capable of impacting a chemical reaction is embedded in said matrix material; wherein said at least one susceptor component is capable of thermal activation through radiofrequency or microwave radiation. This invention also relates to remote thermal activation or heating of such susceptor component within the matrix material such that a releasable ingredient in proximity to the susceptor component is activated or released from, or in proximity to, the matrix to perform its function, for example in conducting chemical reactions such as polymerizations. This invention also relates to preparing such matrix particles.

### FIELD OF THE INVENTION

This invention relates to a matrix particle, comprising: (i) a matrix material, wherein said matrix material is capable of fully or partially altering its physical or chemical characteristics; (ii) at least one susceptor component, wherein said at least one susceptor component is embedded in said matrix material; and (iii) at least one releasable ingredient, wherein said at least one releasable ingredient is capable of impacting a chemical reaction is embedded in said matrix material; wherein said at least one susceptor component is capable of thermal activation through radiofrequency or microwave radiation. This invention also relates to remote thermal activation or heating of such susceptor component within the matrix material such that a releasable ingredient in proximity to the susceptor component is activated or released from, or in proximity to, the matrix material to perform its function, for example in conducting chemical reactions such as polymerizations. This invention also relates to preparing such matrix particles.

### BACKGROUND

In composite manufacturing, eliminating gross heating provides for higher throughputs and eliminates the need to cool parts of equipment or molded materials before removing them from molds. Currently, polymerization can be initiated by two-component mixing to achieve a completed reaction system, by activating a catalyst by light or by grossly heating a composition or similar. Each has limits by default. Gross heating takes a long time, uses a maximum amount of energy and associated complex equipment and leaves behind, through heating and cooling, limited performance with excess material due to built-in stresses from polymerization. Gross heating cannot be used in an adhesive application with elastomeric substrates with glass transition temperatures lower than room temperatures. Two-component mixing can have the same or worse complexity and requires complex mixing or metering equipment to achieve even curing and appropriate mix ratio respectively. Light, by default is limited to clear objects, can only cure thinner objects, requires special packaging to prohibit light, excess catalyst amounts typically beyond 1% and typically inputs excess thermal energy and again requires complex equipment. On the other hand, active catalyst and co-catalyst embedded in the matrix particle improves the shelf life of the products. For example, in B-staged products such as thermoset prepregs and film adhesives, to improve the shelf life and usable time the products are kept frozen until use.

In composite manufacturing, eliminating the gross heating will help achieve higher throughputs as it the step of cooling before de-molding elements from a mold is rendered unnecessary.

It is a desire in industrial manufacturing or processing to not utilize gross heating, to cure larger objects on-demand as with light, to not utilize complex curing equipment, to eliminate the need for complex and metal-based molding equipment and to minimize catalyst loadings as well two-part systems or limited pot life for a two-part system.

In adhesion, gross heating limits the use of thick substrates with higher glass transition temperatures. Higher molecular weight materials pose challenges in accepting higher loadings of fillers or reinforcements such as milled carbon fibers and glass fibers. Use of low molecular weight materials would enable use of higher filler content. Uniform mixing of the fillers and higher performance without rheological issues would be an advantage of using low molecular weight materials.

Unless an object it sufficiently transparent to allow a substantial transmission of light, chemistry activation through opaque objects is often limited as described above. There is a need for a technology capable of penetrating opaque materials, especially through a substantial distance. This would afford the new ability to initiate polymerization in an object filled with a variety of fillers to varying extents without the need for heat and without the limitations of light transmission if even possible.

As the art stands today, ingredient release in a chemical reaction must be caused by the external environment of a chemical reaction chamber, versus by an event caused from within the particle. This is similar to bulk heating, or if using external light, it would be limited by thin dimensions.

Overall, there is a need to activate chemistry and achieve the elimination of gross heating, minimization of energy use, minimization of materials, and minimization of catalyst use to achieve high-speed chemistry as desired, eliminate equipment complexity and minimize its cost and space, minimize or eliminate invasive procedures and to achieve on-demand activation.

### SUMMARY OF THE INVENTION

In one embodiment, this invention relates to a matrix particle, comprising:
(i) a matrix material, wherein said matrix is capable of fully or partially altering its physical characteristics;
(ii) at least one susceptor component, wherein said at least one susceptor component is embedded in said matrix material, and wherein said at least one susceptor component is capable of thermal activation through electromagnetic radiation; and
(iii) at least one releasable and/or activatable ingredient embedded in said matrix and in proximity to said susceptor component, wherein said at least one releasable and/or activatable ingredient is capable of impacting a chemical reaction.

In another embodiment, this invention relates to a matrix particle as recited above, comprising one or more matrices that fit in discrete zones, said discrete zones being in one or more shape; wherein the discrete zones comprise coatings or varied layers; wherein each zone comprises from about zero to multiple susceptors and/or releasable ingredients; and wherein the matrix particle, in the aggregate, has at least one zone comprising a susceptor and at least one zone containing a releasable ingredient.

In yet another embodiment, this invention relates to a matrix particle as recited above, wherein said matrix is derived from and/or contains organic, inorganic, monomeric, oligomeric, polymeric materials, or a combination thereof.

In another embodiment, this invention relates to a matrix particle as recited above, wherein said at least one susceptor is selected from the group consisting of fullerene compounds, graphene, single-wall carbon nanotubes, multi-wall carbon nanotubes, carbon nanofibers, carbon nanotubes, doped carbon nanotubes, carbon sheets, one or more ferrous metals, oxides of one or more ferrous metals, super paramagnetic iron oxides (SPIONs), one or more non-ferrous metals, oxides of one or more non-ferrous metals, transition metals, transition metal oxides, silicon carbide-based material, boron nitride, and one or more combinations thereof.

In yet another embodiment, this invention relates to a matrix particle as recited above, wherein the dimensions of the susceptor are in the range of from about 0.1 nm to about 1000 μm.

In one embodiment, this invention relates to a matrix particle as recited above, wherein the susceptors comprise functionalized susceptors, non-functionalized susceptors, or both functionalized and non-functionalized susceptors.

In another embodiment, this invention relates to a matrix particle as recited above, wherein the susceptor is in the geometric center of a matrix material in direct or indirect contact with the susceptor.

In yet another embodiment, this invention relates to a matrix particle as recited above, wherein the susceptor and/or the releasable ingredient are in an outer layer of the matrix particle, wherein the susceptor and the releasable ingredient are in direct or indirect contact.

In one embodiment, this invention relates to a matrix particle as recited above, wherein the matrix particle are partially or wholly coated in one or more layers of a deformable material.

In another embodiment, this invention relates to a matrix particle as recited above, where the matrix particle is are partially or wholly coated in one or more layers of a deformable material wherein one or more of said layers contains a susceptor and or a releasable ingredient.

In yet another embodiment, this invention relates to a matrix particle as recited above, wherein the matrix material contains no susceptors or releasable ingredient.

In one embodiment, this invention relates to a matrix particle as recited above, wherein said at least one releasable and/or activatable ingredient is a single chemical, a combination of chemicals, organic chemicals, and/or inorganic chemicals.

In another embodiment, this invention relates to a matrix particle as recited above, wherein said chemical ingredient comprises one or more catalysts, co-catalysts, co-reactants, oxidizers, reaction-inhibiting compounds, accelerators, fuels, explosives, or one or more combinations thereof.

In yet another embodiment, this invention relates to a matrix particle as recited above, wherein the releasable ingredient is released when the matrix is deformed, dissolved, melted, expanded, contracted, ruptured, plasticized, solvated, or one or more combinations thereof.

In one embodiment, this invention relates to a matrix particle as recited above, wherein the electromagnetic radiation frequency is in the range of from about 300 MHz to about 300 GHz.

In another embodiment, this invention relates to a matrix particle as recited above, wherein the electromagnetic radiation frequency is in the range of from about 915 MHz to about 2.450 MHz.

In yet another embodiment, this invention relates to a matrix particle as recited above, wherein the electromagnetic radiation frequency is in the range of from about 915 MHz to about 2.450 MHz and/or the power is in the range of 1-10,000 W.

In another embodiment, this invention relates to a matrix particle as recited above, wherein the matrix particle is subjected to electromagnetic radiation frequency as described above for 10 seconds to 60 minutes.

In one embodiment, this invention relates to a matrix particle as recited above, wherein said matrix is optionally supported with a support comprising a metal, a ceramic, or a glass.

In another embodiment, this invention relates to a matrix particle as recited above, wherein the particle is further chemically surface modified via one or more chemical reactions, optionally comprising a releasable ingredient, optionally then forming a partial or complete coating.

In yet another embodiment, this invention relates to a matrix particle as recited above, further possessing a chemical functionality.

In one embodiment, this invention relates to a matrix particle as recited above, wherein the releasable ingredient comprises a chemically functional monomer, wherein the matrix material comprises a polymerized material, and optionally, the matrix particle is coated with a polymerized coating.

In another embodiment, this invention pertains to a process for preparing the matrix particle as recited above, the process steps comprising:
(i) emulsion, dispersion, and/or suspension polymerization, or
(ii) core-shell polymerization.

In yet another embodiment, this invention pertains to a process for preparing the matrix particle as recited above, the process comprising:
(i) coating a polymeric microparticle with a material comprising susceptors and releasable ingredients,
(ii) encapsulating a microparticle in which susceptors and releasable ingredients are embedded, with a monomeric, oligomeric, or a polymeric material,
(iii) amalgamating the susceptors and releasable ingredients, and/or
(iv) entrapping the susceptors and releasable ingredients into external pores on the surface or internal pores in the core of the porous microspheres.

In one embodiment, this invention pertains to a process for preparing the matrix particle as recited above, the process steps comprising copolymerization, wherein said copolymerization step comprises emulsion, dispersion, suspension polymerization or combinations thereof.

In one embodiment, this invention pertains to a process for impacting a chemical reaction, comprising:
(i) providing a bulk reaction mixture;
(ii) providing matrix particles as recited above; and
(iii) incorporating the matrix particles in the bulk reaction mixture.

In another embodiment, this invention pertains to a process for impacting a chemical reaction as recited above, further comprising:
(iv) impinging the bulk reaction mixture with at least one frequency of RF radiation and/or at least one frequency of MW radiation, at least once, on to thermally activate said susceptor component embedded within the matrix particles.

In yet another embodiment, this invention pertains to a process for impacting a chemical reaction as recited above, wherein the impinging of the at least one frequency of RF radiation and/or at least one frequency of MW radiation is performed periodically, wherein the period is regular or irregular.

In one embodiment, this invention pertains to a process for impacting a chemical reaction as recited above, wherein the electromagnetic radiation comprises wavelengths ranging from about one meter to one millimeter; and frequencies ranging between 50 MHz and 30 GHz.

In another embodiment, this invention pertains to a process for impacting a chemical reaction as recited above, wherein the electromagnetic radiation frequency is in the range of from about 915 MHz to about 2.450 MHz.

In yet another embodiment, this invention pertains to a process for impacting a chemical reaction as recited above, wherein the electromagnetic radiation frequency is in the range of from about 915 MHz to about 2.450 MHz and/or the power is in the range of 1-10,000 W.

In one embodiment, this invention pertains to a process for impacting a chemical reaction as recited above, wherein said reaction is a polymerization reaction.

In another embodiment, this invention relates to a process for releasing a releasable ingredient from a matrix particle as recited above, comprising:
(a) dispersing said matrix particles in a bulk reaction mixture; and
(b) impinging the bulk reaction mixture with at least one frequency of RF radiation and/or at least one frequency of MW radiation, at least once, to thermally activate said susceptor component embedded within the matrix particles.

In yet another embodiment, this invention relates to the matrix particle as described above, wherein the one or more alterable matrix material comprises a wax, one or more of polymethyl methacrylate (PMMA), styrene, or one or more polymers or copolymers thereof.

In one embodiment, this invention relates to the matrix particle as described above, wherein the at least one releasable chemical ingredient comprises an activator or catalyst.

In another embodiment, this invention relates to the matrix particle as described above, wherein the catalyst comprises one or more of Cu-acetyl acetonate, Cu-2-ethyl hexanoate, ferrocene, dimethylaminomethyl ferrocene, or one or more combinations thereof.

In yet another embodiment, this invention also relates to an article prepared using the process as described above.

In yet another embodiment, this invention relates to an article prepared using a process as recited above, that is in whole or in part:
(i) a polymerizable composition or several polymerizable compositions of at least one chemistry;
(ii) a reinforced composite article;
(iii) a laminated article;
(iv) a rigid laminated article;
(v) a flexible laminated article;
(vi) a foam; or a
(vii) combination thereof.

In one embodiment, this invention also relates to a composition comprising the matrix particle as recited above, wherein said composition is an adhesive, sealant, coating, paint, ink, plastic, molded plastic, thermoset plastic, molded thermoset plastic, or other polymer forming composition, in whole or part.

In another embodiment, this invention relates to the matrix particle as recited in above, wherein the releasable and/or activatable ingredient is a catalyst selected from the group consisting of transition metal complexes; transition metal alkoxides; stannous (II) bis(2-ethylhexanoate); carboxylates, alkoxide, and complexes of stannous, bismuth, zinc, titanium; blocked super acids; dodecyl benzene sulphonic acids; dinonyl napthalene sulphonic acids; N,N′,N″-tris(dimethylaminopropyl) hexahydrotriazine; organic bases; 1,8-diazabicyclo [5.4.0] undec-7-ene; 1,5-diazabicyclo [4.3.0] nonene-5); (1,4-diazabicylo 2.2.2 octane); and combinations thereof.

### BRIEF DESCRIPTION OF DRAWINGS

FIG. 1 depicts a schematic of the process of the present invention.

FIGS. 2A and 2B depicts the reaction injection molding process currently available, and the process as simplified by the present invention, respectively.

FIGS. 3A and 3B depicts a film-laminating adhesives currently available and the process simplified as a result of the invention, respectively.

FIG. 4 depicts exemplary general structures of matrices of the invention as contemplated herein as well as coated matrices.

FIGS. 5A and 5B depict exemplary compositional structures of the matrices of the invention as contemplated herein.

FIG. 6 depicts exemplary matrices and coated matrices of the invention as contemplated herein. The matrices can be coated on objects or positioned within coatings on various objects.

FIG. 7 depicts scanning electron micrograph (SEM) images of exemplary hollow particles.

FIG. 8 depicts SEM images of exemplary hollow particles plus SPIONs plus copper.

FIG. 9 depicts an SEM image of the commercial PMMA (MX 500-ML, Soken) coated with carbon nanotubes (CNTs).

FIG. 10 is a graph of heating curves using carbon nanostructure (CNS) susceptors.

FIG. 11 is a diagram showing the selective placement of susceptors in the shell on the particles of the present invention.

FIG. 12 is a diagram showing a sheet created through non-covalent interactions.

FIG. 13 depicts a schematic of functionalized CNTs located in the shell of the particles of the present invention.

FIG. 14 depicts a diagram showing the post-functionalization of microparticles for chelating a catalyst.

FIG. 15 depicts a schematic showing the entrapment of CNTs and susceptors using a micellar microparticle.

FIG. 16 depicts a schematic showing entrapment of a catalyst on microparticles and CNTs in a micelle.

FIG. 17 depicts a diagram of the chelation of a catalyst and entrapment of a susceptor using a micellar microparticle.

FIG. 18 depicts core shell particles generated using commercial aqueous emulsions.

### DETAILED DESCRIPTION OF THE INVENTION

Generally speaking, this invention relates to a matrix particle, comprising:
(i) a matrix material, wherein said matrix material is capable of fully or partially altering its physical and/or chemical characteristics;
(ii) at least one susceptor component, wherein said at least one susceptor component is embedded in said matrix material; and
(iii) optionally, at least one releasable ingredient embedded in said matrix material, wherein said at least one releasable ingredient is capable of impacting a chemical reaction;
wherein said at least one susceptor component is capable of thermal activation through RF or MW radiation.

In another embodiment, the matrix particles described above are incorporated or dispersed in a chemical reaction mixture with constituent reactants likely to undergo a chemical reaction, for example within monomers or oligomers of a polymerization reaction. In a further embodiment of the invention, the chemical reaction mixture with the dispersed matrix particles is impinged with radio frequency electromagnetic radiation or microwave radiation. The EMR (Electro Magnetic Radiation) heats the susceptor component in the matrix particles. In turn, this heating releases the active ingredient, which, then, catalyzes the reaction in the reaction mixture. Therefore, the reaction starts only when the RF or the MW radiation releases the ingredients of from the matrix particle.

### Definitions

By “alterable matrix,” or “altering matrix,” is meant that the matrix material within the matrix particle can be fully or partially deformed, dissolved, melted, expanded, contracted, ruptured, plasticized, or solvated. In other words, its physical and/or chemical form can be altered to render it amenable to releasing the active ingredient.

By “susceptor,” is meant the particle within the matrix particle that is amenable to being heated or thermally activated by the electromagnetic radiation, particularly, radio frequency and/or microwave.

By “impacting a chemical reaction,” is meant that the releasable ingredient can activate or trigger, catalyze, co-catalyze, promote, accelerate, co-accelerate, inhibit, and/or heat a chemical reaction.

By “matrix material,” or “matrix,” is meant the base material in a matrix particle in which the susceptor component and/or the releasable and/or activatable ingredients are embedded. The base material, for example, can be monomeric, oligomeric, or polymeric, or inorganic.

By “embedded,” is meant the susceptors or the releasable and/or activatable ingredients are encapsulated or entrapped within the matrix material, in intimate or associated contact with said matrix; for example in the pores of the matrix, or are bonded to one or more matrix materials, may be within the matrix or on one or more surfaces of the matrix material, fully encapsulated within the matrix material, or partially embedded within the matrix particle by physical adhesion, or are partially protruding at the surface of the matrix particle.

By “matrix particle,” is meant the nano or microparticle comprising a matrix material, the susceptor component, and the releasable and/or activatable ingredient, which is used for thermal activation of the bulk reaction mixture as recited in the present invention.

By “EM,” is meant high-frequency electromagnetic radiation such as radio frequency (RF) or microwave (MW).

By “releasable and/or activatable ingredient,” is meant the ingredient that is comprised within a matrix microparticle which plays the role of impacting the chemical reaction upon remote thermal activation of the susceptor within the matrix particle that then releases or activates the releasable and/or activatable ingredient. As an alternative to the term “releasable and/or activatable ingredient,” the term “active ingredient” or the “releasable ingredient” is used. In other words, the active ingredient embodies its releasability characteristic as well as activity characteristic. The active ingredient is an active chemical ingredient in many embodiments as described infra.

By “bulk reaction mixture,” is meant the reaction mixture that can be impacted by the matrix particle upon release of the active ingredient. In the bulk reaction mixture, the matrix particles are dispersed, to then have a remote activation of the susceptors to release the active ingredient, for example, to catalyze the bulk reaction mixture. As a matter of example, the bulk reaction mixture can be a pre-polymerization material, and even post-polymerization materials to increase molecular weight, for example, any other chemical reaction such as an organic or an inorganic, or a combined organic-inorganic reaction. The bulk reaction mixture can be clear, translucent, or opaque. Or the bulk reaction mixture can change its transparency as the reaction progresses.

In another embodiment, this invention relates to the process of incorporating the matrix particle in a chemical reaction mixture to impact the chemical reaction. For example, the matrix particles can be dispersed in the monomeric mixture prior to polymerization. In another embodiment, this invention relates to activating the chemical reaction, for example the polymerization reaction, by heating the susceptor in the matrix particle by high-frequency electromagnetic radiation (EMR) such as radio-frequency (RF) or microwave (MW) radiation to then release or activate the releasable and/or activatable ingredient.

The present disclosure relates to materials and methods for performing chemical reactions, for example, polymerization reactions wherein a chemical event is activated, uniformly, and on demand. The reactions as contemplated herein can be accomplished without needing to heat the entire reaction material mass; without the limitation of light such as infrared, ultraviolet, or visible penetration especially for highly filled material masses, opaque material masses and the like.

In some embodiments, the present invention relates to materials and methods for polymerization without the need to mix two reaction components, and in some embodiments with the ability to mix two components but not have an immediate or accelerated reaction and/or have a delayed reaction, on demand. For example, some embodiments of the present disclosure provide low molecular weight and high-performing materials for reducing cure times in polymerization to minutes or hours and in mold-making to a day or a few weeks. In one embodiment, this invention can inhibit a chemical event by activation of a chemical ingredient.

In some embodiments, the present disclosure provides materials and methods for polymerization that reduce or eliminate the need for higher molecular weight materials where high pressure is consequently required along with high temperatures, for example, in injection molding and reaction injection molding, and instead allowing for increasing of molecular weight while in process or within the mold, and on demand. Preferably, the matrix particles have matrix materials that are of low molecular weight. The low molecular weight matrix particles of the present invention provide uniform mixing of fillers and provide higher performance adhesion without unwanted rheological issues. The invention allows for less complex equipment and on-demand curing that simplifies material preparation, storage, packaging, and handling.

The low molecular weight matrix particles provided by the present disclosure can be applied as adhesives to various materials with various applications. The present invention also provides for local heating or thermal activation. The matrix particles as described herein provide the ability to activate polymerization on demand. Polymerization as provided herein can be activated through substrates, fillers, other additives and the like. In other words, the opacity or lack of transparency of the bulk chemical mixture or pore-polymerization mixture does not significantly impact the reaction progression. The low molecular weight matrix particles as described herein, provide for polymerization without relying on gross heating or thermal activation.

The low molecular weight materials, that is, the matrix particles, of the present invention can be applied to a substrate in a pattern, thereby providing for a patterned adhesive. Embodiments of the low molecular weight matrix particles of the present invention can be applied in a patterned manner thereby providing a patterned adhesive that includes both two and three-dimensional selective activation.

In some embodiments, the matrix particles as described herein provide on-demand polymerization for adhesives for producing converted goods, including rigid and or flexible laminates with two or more layers. In some embodiments, the matrix particles as described herein provide polymerization for adhesives for pressure-sensitive materials and their associated goods.

In one embodiment, the low molecular weight matrix particles of the present disclosure provide improved curing for adhesives, coatings, and the like. This also includes substrates to pass energy through, such as highly filled material masses, opaque material masses and the like.

Embodiments of the present invention provide materials and methods for improved non-metallic molding, polymeric molding, and high-speed mold making and delivery.

This process can also occur under ambient conditions. The thermal activation to engender the local chemical event is accomplished by applying electromagnetic radiation (EMR) such as radio frequency (RF) radiation or microwave (MW) radiation. This invention is applicable to bonding polymeric substrates, such as elastomeric and rigid substrates, including fabrics and laminates.

For example, a matrix that dissolves, melts, expands, cracks, ruptures, and/or otherwise deforms due to the heating of the susceptor component such as a carbon nanotube to release or activate a chemical ingredient such as a catalyst that then catalyzes the reaction, for example, a polymerization reaction or a reaction that leads to a rapid energy generating reaction.

### Polymerization Energy Minimization and Fine Polymerization Control

In one embodiment, this invention also relates to minimizing the energy required to activate chemical reactions and their effects, specifically avoiding gross heating, limited energy penetration as with, for example UV light, and the ability to activate one or more chemical events on demand, in whatever order or series desired to achieve the desired result.

### Activating Chemistry and Polymerization Through Opaque Objects

Uncontrolled and fast reactions in UV curing chemistries can result in highly cross-linked systems. In some applications that require toughness, uncontrolled UV cure reaction leads to unwanted vitrification and brittleness. Embodiments of the present invention provide uniform distribution of the catalyst/co-catalyst, as components of the matrix particles, in the reaction mixture. Without being bound to theory, this uniform distribution in the reaction mixture enables the simultaneous initiation of a polymerization reaction at multiple sites that helps the creation of a homogenous polymeric network. Without being bound to theory, the simultaneous reaction at multiple sites results in a controlled exotherm and improved efficiencies.

Embodiments of the present invention provide activation of catalysts of polymerization at one or more depths on a matrix material. The catalyst may be on the surface of the matrix material or a depth below the surface or embedded within the matrix material. For example, the catalyst may be positioned at a depth below the surface of up to about 0.01 μm, from about 0.01 μm to about 0.05 μm, from about 0.05 μm to about 0.1 μm, from about 0.1 μm to about 0.2 μm, from about 0.2 μm to about 0.3 μm, from about 0.3 μm to about 0.4 μm, from about 0.4 μm to about 0.5 μm, from about 0.5 μm to about 0.6 μm, from about 0.6 μm to about 0.7 μm, from about 0.7 μm to about 0.8 μm, from about 0.8 μm to about 0.9 μm, from about 0.9 μm to about 1 μm, from about 1 μm to about 5 μm, from about 5 μm to about 10 μm, or greater than about 10 μm and any and all increments therebetween.

In one embodiment, this invention relates to solid-state polymerization, in which the molecular weight is built up over time, where the polymer is already in a solid state or a highly viscous state, but with the inclusion of matrix microparticles, and the treatment with RF or MW, the polymerization yield or the molecular weight can be increased, for example, in situ.

### Particle Composition and Structure

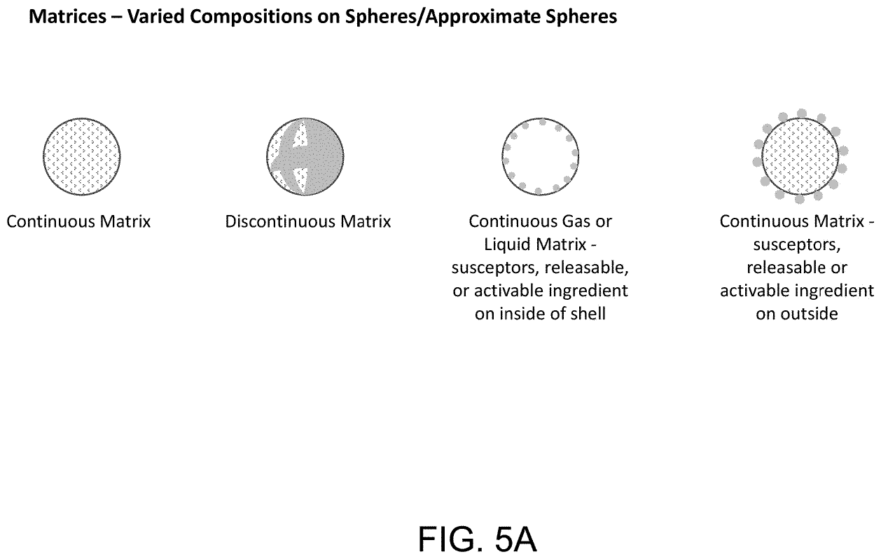

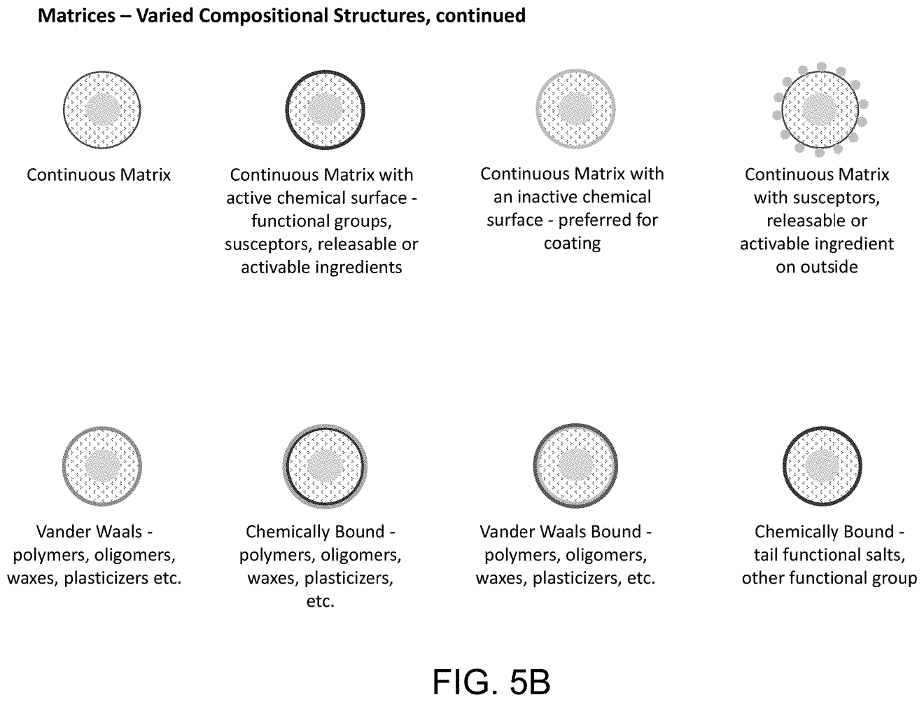

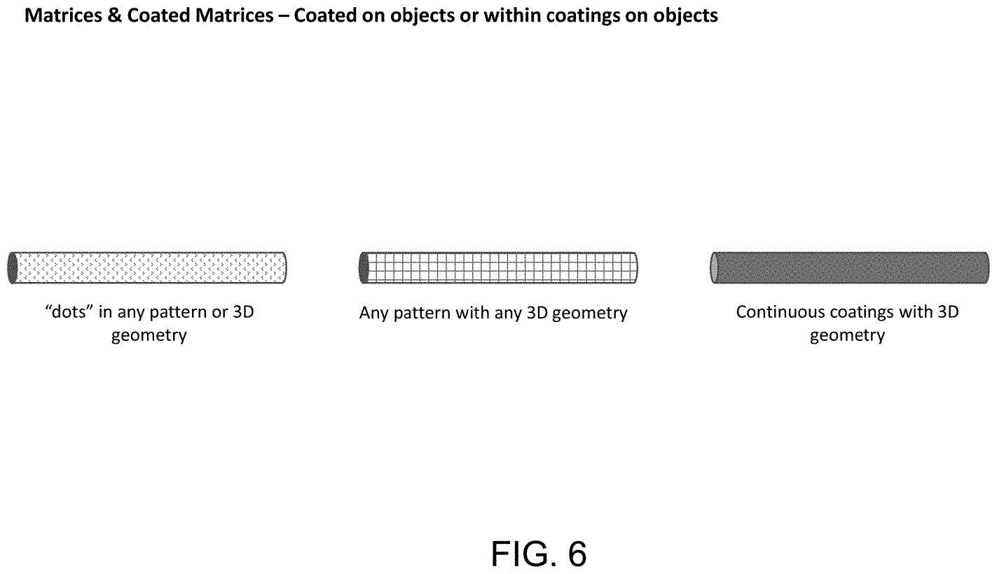

Referring now to FIGS. 5A and 5B, in some embodiments, the matrix particles of the present invention can be of highly varied composition. The matrix material can optionally be deformable. In some embodiments, multiple matrices are used in one embodiment. In some embodiments, one or more susceptor component can be used. In some embodiments, one or more releasable and/or activatable ingredients are contained within or on the matrix. In some embodiments, the one or more releasable and/or activatable ingredient includes one or more of a catalyst, a co-catalyst, a co-reactant, fuel, an explosive, another ingredient, and mixtures thereof. In some embodiments, the releasable and/or activatable ingredients are released by one or more means including for example dissolving, expansion, cracking, light, and/or one or more combinations thereof.

### Alterable Matrix Material

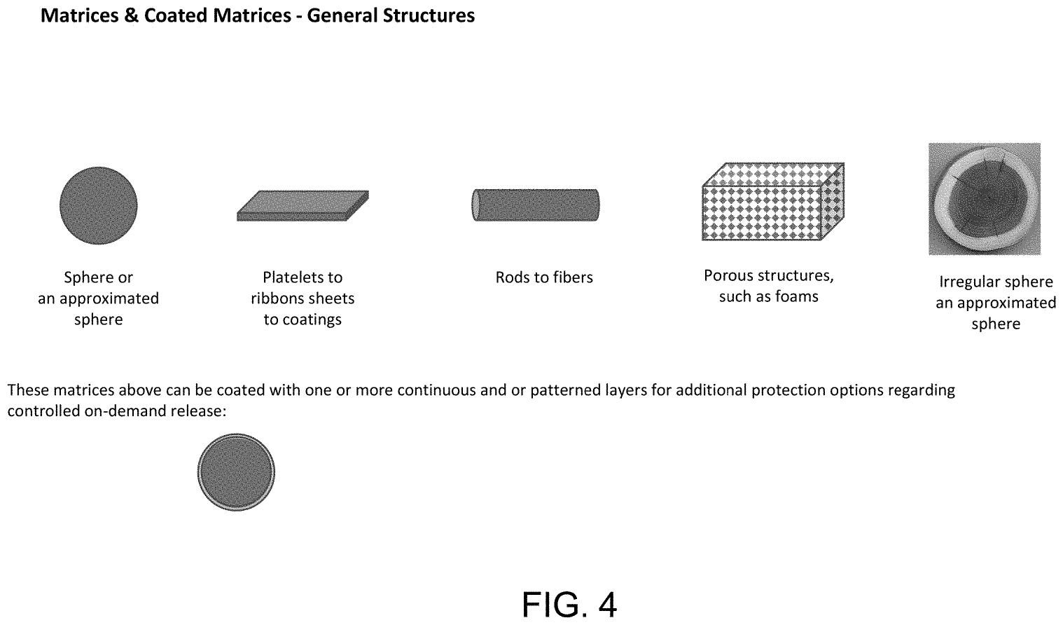

As used herein, “alterable matrix” refers to a material that when heated is capable of deforming, dissolving, melting, rupturing, expanding, contracting, plasticizing and/or solvating in such a way as to release its active ingredient, for example, chemical contents. The matrix particle may have almost any geometric configuration, geometry, or size. For example, as shown in FIG. 4, the matrix particle may be formed in a shape including one or more of a sphere, thin plate, ribbon, sheet or coating, a rod or distended fiber, a porous structure including for example a foam, or one or more irregular or amorphous shapes.

In some embodiments, shown in FIGS. 5A and 5B, the matrix material is continuous. In some embodiments, the matrix material has an isotropic structure. In some embodiments, the matrix material is discontinuous. In some embodiments, the matrix material has an anisotropic or orthotropic structure. In some embodiments, the matrix material is a mixture of one or more materials or structures. In some embodiments, the matrix material includes a mixture of isotropic and anisotropic structures.

The matrix material can be composed of any suitable material as understood in the art. In some embodiments, the matrix material can be monomeric, oligomeric, or polymeric. For example, the matrix can comprise methyl methacrylate. In some embodiments, the matrix material is composed of polymeric microparticles. For example, the polymeric microparticles can be made from polymethyl methacrylate (PMMA), styrene, and/or one or more polymers or copolymers thereof. The microparticles can also be blends, alloys, and mixtures of polymers.

The polymeric microparticles can include polymeric microspheres and microcapsules. The microcapsules can be porous or can be partially open.

In some embodiments, the microparticles are spherical microparticles. The microparticles can have an effective diameter of from about 0.1 μm to about 1000 μm. As used herein, “effective diameter” refers to the diameter of an equivalent spherical microparticle of the same volume or weight. For example, the microparticles can have an effective diameter of from about 0.1 μm to about 0.5 μm , from about 0.5 μm to about 1 μm, from about 1 μm to about 5 μm, from about 5 μm to about 10 μm, from about 10 μm to about 50 μm, from about 50 μm to about 100 μm, from about 100 μm to about 200 μm, from about 200 μm to about 300 μm, from about 300 μm to about 400 μm, from about 400 μm to about 500 μm, from about 500 μm to about 600 μm, from about 600 μm to about 700 μm, from about 700 μm to about 800 μm, from about 800 μm to about 900 μm, from about 900 μm to about 1000 μm, and any and all increments therebetween.

In one embodiment, the effective diameter of the microparticle is one of the numbers as measured in μm, or one of the numbers within a range defined by any two numbers below, including the endpoints, in μm:

0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, and 1,000.

In one embodiment, the microspheres as referred to herein, are microparticles composed of a homogeneous and solid polymer matrix material, while microcapsules are core-shell microparticles where the core may be solid, liquid, or even hollow spaces. The microparticles can also be prepared as a porous matrix material composed of interconnected microspheres. The porous matrix material can include pores that form on the surface or that are external and/or pores that form internally. The pores can be isolated or interconnected. The pores lead to very low mass density matrix material. The pores are suitable for entrapping susceptors and releasable and/or activatable ingredients, such as activators, catalysts, co-catalysts, co-reactants, oxidizers, reaction inhibitors, accelerators, and/or one or more other releasable ingredients.

In some embodiments, the matrix material is composed of monodispersed polymeric particles. In some embodiments, the matrix material is composed of polydispersed polymeric particles. The polydispersion may include a narrow dispersion of particle sizes, for example, a monomodal distribution, a bimodal distribution, or a trimodal distribution. In some embodiments, the polydispersion includes a middle-dispersion of particle sizes. In some embodiments, the polydispersion includes a wide dispersion of particle sizes. In some embodiments, the polydispersion includes particle sizes ranging from about 1 nm to about 10 nm, from about 10 nm to about 50 nm, from about 50 nm to about 100 nm, from about 100 nm to about 200 nm, from about 200 nm to about 400 nm, from about 400 nm to about 600 nm, from about 600 nm to about 800 nm, from about 800 nm to about 1000 nm, about 1 μm, from about 1 μm to about 1.5 μm, from about 1.5 μm to about 2 μm, from about 2 μm to about 2.5 μm, from about 2.5 μm to about 3 μm, from about 3 μm to about 3.5 μm, from about 3.5 μm to about 4 μm, from about 4 μm to about 4.5 μm, from about 4.5 μm to about 5 μm, and any and all increments therebetween. In some embodiments, the average particle size is up to about 0.1 μm. In some embodiments, the average particle size is in the range of from about 0.1 μm to about 0.5 μm, from about 0.5 μm to about 0.8 μm, from about 0.8 μm to about 1 μm, from about 1 μm to about 1.2 μm, from about 1.2 μm to about 1.5 μm, from about 1.5 μm to about 1.8 μm, from about 1.8 μm to about 2 μm, from about 2 μm to about 4 μm, from about 4 μm to about 6 μm, from about 6 μm to about 8 μm, from about 8 μm to about 10 μm, from about 10 μm to about 20 μm, from about 20 μm to about 40 μm, from about 40 μm to about 60 μm, from about 60 μm to about 80 μm from about 80 μm to about 100 μm, from about 100 μm to about 200 μm, from about 200 μm to about 400 μm, from about 400 μm to about 600 μm, from about 600 μm to about 800 μm, from about 800 μm to about 1000 μm, and any and all values therebetween.

In some embodiments, the matrix material in the matrix particles has a molecular weight of up to 10 kDa. In some embodiments, the matrix material in the matrix particles have a molecular weight of from about 10 kDa to about 25 kDa, from about 25 kDa to about 50 kDa, from about 50 kDa to about 75 kDa, from about 75 kDa to about 100 kDa, from about 100 kDa to about 125 kDa, from about 125 kDa to about 150 kDa, from about 150 kDa to about 175 kDa, from about 175 kDa to about 200 kDa, from about 200 kDa to about 225 kDa, from about 225 kDa to about 250 kDa, and any and all increments therebetween. Matrix materials, with much higher molecular weight, for example, that of branched or crosslinked polymers such as rubber is also within the scope of this invention.

In some embodiments, the matrix material has a molecular weight as provided by any number below, in kDa, or by a number within a range defined by any two numbers below, including the endpoints of such a range, in kDa:

200, 300, 400, 500, 600, 700, 800, 900, 1000, 1100, 1200, 1300, 1400, 1500, 1600, 1700, 1800, 1900, 2000, 3000, 4000, 5000, 6000, 7000, 8000, 9000, 10000, 20000, 30000, 40000, 50000, 60000, 70000, 80000, 90000, 100000, 200000, 300000, 400000, 500000, 600000, 700000, 800000, 900000, and 1000000.

In some embodiments, the dispersion of polymeric particles includes particles with a low level of crosslinking. In some embodiments, the dispersion of polymeric particles includes particles with a standard or intermediate level of cross-linking. In some embodiments, the dispersion of polymeric particles includes particles with a high level of cross-linking.

### Susceptors

In some embodiments, the matrix particle composition of the present disclosure includes one or more susceptors. The susceptors as contemplated herein are particles that can be heated or otherwise activated to generate heat. The susceptors are composed of materials that create higher heating rates or lower thermal capacity than the surrounding or adjacent matrix materials. The higher heating rates of the susceptors result in altering—as defined previously—of the matrix upon application of an energy source without bulk heating of the matrix material. The heated susceptors can induce deformation of the matrix material so that components or chemical ingredients that can impact reactions, such as catalysts or inhibitors within the matrix, can participate in one or more chemical reactions. Embodiments of the susceptors that can be heated include one or more carbon-based or silicon carbide-based materials. The susceptors may include one or more ferrous or non-ferrous metals including for example, one or more transition metal oxides, ferrites, and the like, and/or one or more combinations thereof. Transition metals include Ti, V, Cr, Mn, Fe Co, Ni, Cu, and Zn.

Embodiments of ferrous susceptors include one or more ferrite powders, superparamagnetic iron oxide (SPION) particles, and the like, including one or more combinations thereof. Embodiments of the susceptors include one or more of graphene, fullerenes, single-wall carbon nanotubes, multi-wall carbon nanotubes, carbon nanofibers, filled or doped carbon nanotubes, carbon sheets, bucky paper, and the like, including one or more combinations thereof.

Embodiments of the susceptors are composed of one or more materials that generate heat when exposed to radio frequency (RF) radiation and/or microwave (MW) radiation; microwave heating is used as an example for describing the process of the present invention, infra. Externally applied microwaves can generate matrix heating internally. Without being bound to theory, unlike conventional means of bulk heating, microwave-induced heating rates are not limited to the rate of heat transfer from external heat sources to the inside of the bulk reaction mixture. Accordingly, microwave heating is more efficient than conventional heating. That is, microwave heating provides a faster and uniform heating of the bulk reaction mixture that has matrix particles of the present invention dispersed into the bulk reaction mixture. Furthermore, conventional heating occurs via heat flow from the external heat sources while conventional heating propagates from the surface to the core of the bulk reaction mixture by one or more means, including conduction and/or convection, and through and mixing.

As such, the surface of the bulk reaction mixture often remains at higher temperature than the core of the bulk reaction mixture. For example, the outside surface of a reaction vessel in immediate contact with the bulk reaction mixture will heat up the immediate vicinity of the bulk reaction mixture, with a progressively declining temperature to the core. Even if an equilibrium temperature is established, the wall of the bulk reaction mixture proximate to the reaction vessel will likely have a higher to a much higher temperature, introducing a non-uniform yield and chemical properties of the bulk reaction mixture progressing towards an end-product. For example, in a polymerization reaction, the bulk reaction mixture, starting out with monomers and oligomers, and if dependent on temperature, will either have a distribution of molecular weight from outside to the core of the bulk reaction mixture, or will have a higher degradation closer to the reaction vessel, or will have higher gelling/crosslinking at the reaction vessel walls.

This can result in uneven heating, overheating, and/or underheating creating reaction non-uniformity, which can then affect yield or create problems with other reaction parameters. However, because microwave heating can uniformly occur whether at the core or the outside of the bulk reaction material, because the microwaves penetrate matrix materials and thermally activate or excite the susceptors within the core of the bulk material nearly simultaneously, it generates heat inside the bulk material allowing the core of the matrix to generally remain at even a higher temperature than the surface. That is, localized heating sources can be engendered that are very small in dimension.

As such, in some embodiments, susceptors are positioned within the core of the matrix particle such as a polymeric matrix material so when microwaves are applied, the susceptors are heated, resulting in heating the core of the matrix particle. In some embodiments, the susceptors are positioned on the surface of the matrix particle, so that when microwaves are applied, local acute heating of the surface of the matrix particle results.

Embodiments of the susceptors are activatable at one or more frequencies or ranges of frequencies. The frequencies may include one or more frequencies within the following ranges: up to about 100 MHz, from about 100 MHz to about 200 MHz, from about 200 MHz to about 400 MHz, from about 400 MHz to about 600 MHz, from about 600 MHz to about 800 MHz, from about 800 MHZ to about 1000 MHz, from about 1000 MHZ to about 1500 MHz, from about 1500 MHz to about 2000 MHz, from about 2000 MHz to about 2500 MHz, from about 2500 MHz to about 5000 MHz, from about 5000 MHz to about 7500 MHz, and any and all increments therebetween. A preferred frequency range is 900 MHz to 2500 MHz.

In some embodiments, the frequencies are one of the numbers below as measured in MHz, or within a range defined by any two numbers below including the endpoints of such range, in MHz:

10, 20, 30, 40, 50, 60, 70, 80, 90, 100, 150, 200, 250, 300, 35, 400,450, 500, 550, 600, 650, 700, 750, 800, 850, 900, 950, 1000, 1500, 2000, 2500, 3000, 3500, 4000, 4500, 5000, 5500, 6000, 6500, 7000, and 7500.

Embodiments of the susceptors include one or more shapes. For example, the susceptors may be spherical, cylindrical, disk-like, tube-like, or cuboidal, and may have one or more other regular polygonal prismed shapes, one or more irregular shapes, and/or one or more combinations thereof.

In some embodiments, the susceptors are functionalized. In some embodiments, the susceptors include both functionalized and unfunctionalized susceptors. In some embodiments, the functional groups include surface functional groups, wherein the functional groups are added by one or more monomeric or polymeric surfactants. For example, in some embodiments, the susceptors may include one or more carboxyl groups, hydroxy groups, methyl groups, and the like. The susceptor may include one or more functional groups that increase or decrease the hydrophilicity, or the hydrophobicity. The susceptors may include different functional groups so that regions of the susceptor are more hydrophilic or hydrophobic than other regions of the susceptor. For example, the susceptors can have functional groups so that the susceptor has a polar end and a nonpolar end.

Releasable and/or Activatable Ingredients

In some embodiments, the matrix material includes one or more releasable and/or activatable ingredients also known as releasable ingredients or active ingredients. The one or more releasable and/or activatable ingredients can be encased or entrapped within the matrix material which can be polymeric or oligomeric or monomeric or a mixture of the three. For example, the one or more releasable ingredients can be physically entrapped or encased within one or more pores of the microparticle matrix material. In some embodiments, the one or more releasable ingredients can be chemically entrapped within the polymeric matrix material. That is, the one or more releasable ingredients can be chemically bonded to one or more materials of the matrix within the matrix particle. The releasable ingredients can include one or more catalysts, co-catalysts, co-reactants, oxidizers, reaction-inhibiting compounds, chelators, initiators, accelerators, activators including surface activators, modifiers, fuels, explosives, and/or one or more combinations thereof. The releasable ingredients can include any chemical, combination of chemicals, organic or inorganic, as understood in the art. In some embodiments, the one or more releasable ingredients can include one or more compounds capable of initiating polymerization, for example, anionic, cationic or free radical polymerizations.

In some embodiments, the one or more releasable ingredients include one or more ingredients that initiate one or more reactions including redox reactions such as that in anaerobic adhesion. For example, the one or more releasable ingredients can include one or more of a hydroperoxide and one or more transition metals. The one or more releasable ingredients can be contained within different microcapsules within the matrix, within different pores, entrapped within the matrix material, bound to one or more components of the matrix material or otherwise are maintained separated, and are only in contact once the matrix material is heated or activated.

In one embodiment, the one or more releasable ingredients include one or more of a metal accelerator or catalyst such as ferrocene or other metallocenes. The one or more catalysts can be combined with peroxides and/or other compounds for activating or deactivating polymerization. In some embodiments, the catalyst includes one or more of Cu-acetyl acetonate, Cu-2-ethyl hexanoate, ferrocene, dimethyl aminomethyl ferrocene, and/or one or more combinations thereof. In some embodiments, the one or more releasable ingredients include one or more free radical stabilizers such as hydroquinone or p-methoxyphenol.

In some embodiments, including for example compositions that include anionic cyanoacrylate and/or methylene malonate, the one or more releasable ingredients can include one or more inorganic bases or organic bases (e.g., sodium propionate). In yet another example, for cationic polymerization of epoxy resins, one or more ingredients such as diaryliodonium and triarylsulfonium, blocked super acids, cationic catalysts are released. In some embodiments, such as in condensation polymerization, the one or more releasable ingredients can include one or more catalysts such as antimony, germanium, titanium, and aluminum compounds.

Fuels and explosives and the like are another example of where such materials could be used. Specifically, one could utilize individually or in combination a fuel or other explosive material with or without additional materials as described to initiate a chemical reaction releasing in various forms a large amount of energy either individually or in combination with other reactive materials to facilitate an event, for example, from powering a piston in an engine, to an explosive device to an incendiary event to a simple high-speed heating event.

In one embodiment, the releasable ingredient can modify physical characteristics of the bulk reaction mixture, for example increase or decrease its viscosity, or provide color or other optical property to the bulk reaction mixture, especially once it reaches its chemical equilibrium to a product, for example.

### Particle Structures

Embodiments of the present disclosure provide matrix particle compositions having a matrix material comprised of one or more particles as described herein, one or more susceptors as described herein, and/or one or more releasable ingredients as described herein. The matrix particle composition may be simply structured as a matrix material containing the susceptor and a releasable ingredient as described supra and may present in any geometric configuration required by an application. For example, the matrix particle may present in a spherical or approximately spherical configuration, a ribbon or sheet-like configuration, a rod-like or fiber-like configuration, a porous configuration including for example a foam, and/or one or more irregular configurations. It should be noted that in some embodiments, the releasable ingredient may not be physically released, but rather, may be chemically activated to perform its function.

In some embodiments, the matrix particle compositions can have varied phases containing either susceptors and/or activatable and/or releasable ingredients. In some embodiments, the matrix particle compositions can have continuous phases which contain both susceptors and/or releasable ingredients. In some embodiments, one or more susceptors or releasable ingredients such as activators/catalysts can be contained in a first layer and/or one or more subsequent or alternating coating layer(s) of the matrix material in the matrix particle composition.

In some embodiments, the particle compositions include hydrophilic chemistries, hydrophobic chemistries, and/or one or more regions with hydrophilic and/or hydrophobic chemistries. In some embodiments, the one or more functionalized susceptors are positioned within or on the particle composition so that the like-charged susceptor functional groups and particle chemistries are aligned. For example, the hydrophilic region of the one or more susceptors aligns with one or more regions of the matrix particle composition having one or more hydrophilic chemistries. Similarly, in some embodiments, the hydrophobic region of the one or more susceptors aligns with one or more regions of the matrix particle compositions having one or more hydrophobic chemistries. As such, the position of the one or more susceptors within or on the matrix particle compositions can be directed by hydrophilic or hydrophobic regions of the matrix particle composition.

Embodiments of the matrix particle composition include configuration wherein the susceptors are combined with the matrix material, and one or more of the releasable ingredients. Embodiments of the matrix particle composition include configurations wherein the susceptors can be present on the surface of a first matrix materials or in another matrix material in contact with the first matrix material. In some embodiments, the particle composition includes a first layer of matrix material, and one or more additional adjacent layers of matrix material. For example, in some embodiments, the matrix particle composition can include a single matrix material or matrix material layer, 2 matrix material layers, 3 matrix material layers, and so on. The matrix particle composition can include one or more homogenous layers, one or more heterogenous layers, and/or combinations thereof. For example, in some embodiments, more than one susceptor or type of susceptor is included in one matrix particle composition. The additional susceptors can be positioned in the same matrix material layer, in adjacent matrix material layers, in alternating matrix material layers, and the like.

In some embodiments, more than one releasable ingredient such as an activator or catalyst is included in the same matrix material layer or a different matrix material layer. The activator or catalysts may be positioned in the same matrix material layer, in adjacent matrix material layers, in alternating matrix material layers, and the like. In some embodiments, more than one releasable ingredient is included in the same matrix material layer or a different matrix material layer. The releasable ingredient may be positioned in the same matrix material layer, in adjacent matrix material layers, in alternating matrix material layers, and the like.

In some embodiments, each matrix material layer comprises one combination of susceptor, activator/catalyst and releasable ingredient such as activator/catalyst. In some embodiments, each matrix material layer comprises more than one combination of susceptor, and releasable ingredient such as an activator/catalyst. In some embodiments, the matrix particle composition includes more than one matrix material layer where each matrix material layer comprises the same combination of susceptor, and releasable ingredient such as an activator/catalyst. In some embodiments, the particle composition includes more than one matrix material layer where each matrix material layer comprises a different combination of susceptor, and releasable ingredient such as an activator/catalyst.

In some embodiments, the matrix particle composition includes more than one matrix material layer where each layer is formulated to have a curing time within the same time interval. In some embodiments, the matrix particle composition includes more than one matrix material layer where each layer is formulated have a curing time at varied time intervals such as in molded structures. In some embodiments, the layered matrix materials are ordered for managing stresses and or other physical properties in the particle composition or in the material in which or on which they are applied. For example, in some embodiments, the particle composition is formulated with different amounts or concentrations of one or more activatable matrix component, activator, catalyst, releasable ingredient or the like.

A matrix particle may, in whole or part, be, optionally supported and or otherwise protected, for example by a crushable or a non-crushable support including for example a metal, ceramic or glass and the like, and in three dimensions like a foam, a solid object coated with or impregnated by the matrix particle composition. Even further by example, an object may present with a roughened, spiked or similar surface texture to, for example, prevent crushing with the matrix material ensconced below but surrounding said structures. Another example could include matrix particle composition as coated beads, particles, granules, and the like, including metal glass beads or even a susceptor as a bead to melt or otherwise deform the matrix particle composition coated on the surface through heating.

In some embodiments, multiple matrices are used if, for example, a particular application demands it. The matrix may be formed in various configurations including one or more coated layers, patterned films or layers, textured geometries, and the like.

In all applications, the susceptors are excited via external, high-frequency, electromagnetic radiation (EMR) to alter, for example, deform or dissolve or melt, in part or whole, the surrounding matrix or matrices to release the catalyst, co-catalyst, inhibitor, co-reactant, or accelerator, fuel, an explosive or other ingredients. In some embodiments, the susceptors, such as CNTs, are excited or activated to heat or thermally activate the matrix. In some embodiments, heating or thermally activating the matrix deforms the matrix material.

The matrix particles offer and efficient way to deliver the susceptors into the formulations used, for example, in adhesives, coatings, composites, molding applications, and polymeric systems. Use of matrix particles as a carrier helps with maintaining the rheological characteristics-for example even at low loadings CNTs causes spikes in viscosities creating processing challenges.

Various susceptors are also used depending on the specific applications. For example, in curing opaque polymers, single and multi-wall carbon nanotubes, sheets, and fiber susceptors generally offer very efficient energy susceptor material for heating and releasing a given catalyst. In other example, where optical clarity is a driving factor, CNTs with boron nitride may be used for transparency.

The size of the susceptor component ranges from nanometer range to micrometer to millimeters in at least one dimension. For example, in some embodiments the susceptor component ranges in size of from about 1 nm to 10 nm, from about 10 nm to about 100 nm, from about 100 nm to about 1 μm, from about 1 μm to about 10 μm, from about 10 μm to about 100 μm, from about 100 μm to about 1000 μm, and any and all increments therebetween.

In some embodiments, the size of the susceptor component is one of the numbers below as measured in nm, or within a range defined by any two numbers below including the endpoints of such range, in nm, or an addition of any two numbers, in nm:

1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, 200000, 300000, 400000, 500000, 600000, 700000, 800000, 900000, and 1000000.

In some embodiments, the susceptors are uniformly dispersed in the matrix material. The dispersion of susceptors can allow the use of optimized weight of the susceptors. In some embodiments, the well-dispersed susceptors can result in strong van der Waals forces between the susceptors and the matrix material, it is theorized without wishing to be bound by any theory as a limitation to the scope of the present invention. The interactions of the susceptors and matrix can also be through both covalent and non-covalent bonding.

The susceptor component may include carbon nanotubes, carbon nanostructures, ferrous particles including superparamagnetic iron oxide nanoparticles (SPIONs), and the like.

The catalyst, co-catalyst, inhibitor, co-reactant, accelerator, fuel, an explosive, other ingredients and the like and mixtures can be of virtually any composition but preferably where the final particles are present at a concentration suitable for the required chemistry. Applications can be very unique and widely varying in their requirements.

In some embodiments, susceptor component concentrations may vary from 0.01% to as much as 10% generally with the application itself and its requirements the final arbiter. Energy requirements derived from deformation temperatures and dynamics, heat transfer to the surrounding matrix, the time frame of the event from thousandths of seconds to tens of seconds or more. In some embodiments, the matrix includes one or more waxes. The waxes can include one or more natural waxes such as carnauba wax. The waxes can include one or more synthetic waxes such as, for example polyethylene wax. The waxes can include a combination of both synthetic and natural waxes such that the combination has a sharp melting point. In some embodiments, the waxes have a melting and/or deformation temperatures in the range of between about 50° C. and 300° C. For example, the wax matrix in some embodiments has a melting temperature of between about 50° and about 75° C., between about 75° C. and about 100° C., between about 100° C. and about 125° C., between about 125° C. and about 150° C., between about 150° C. and about 175° C., between about 175° C. and about 200° C., between about 200° C. and about 225° C., between about 225° and about 250° C., between about 250° C. and about 275° C., between about 275° C. and about 300° C., and any and all increments therebetween.

### Waxes as Matrix Material

By “wax” is meant any naturally occurring or synthetically occurring wax. It also includes blends or mixtures of one or more naturally occurring and/or synthetically occurring waxes. Naturally occurring waxes include plant-based waxes, animal waxes, and mineral waxes. Synthetic waxes are made by physical or chemical processes. Because they are mixtures, naturally produced waxes are softer and melt at lower temperatures than the pure components.

Wax can be paraffin wax that is a linear alkane with a general formula of CₙH₂ₙ₊₂, wherein n varies from 13 to 60. The paraffin wax defined by n=13 is called tridecane and the one with n=80 is octacontane. The melting point of C₁₃ wax is −5.4° C. Similarly, the melting point of the C60 wax is 100° C. Similarly, the melting point of higher waxes (between C60 and C80) is higher than 100° C. Depending upon the temperature range in which the bulk reaction mixture needs to be heated to, one could tailor a wax-based matrix particle with a specific wax core within it that alters, deforms, or melts in that particular temperature range.

Examples of plant-based waxes include mixtures of unesterified hydrocarbons, which may predominate over esters. The epicuticular waxes of plants are mixtures of substituted long-chain aliphatic hydrocarbons, containing alkanes, alkyl esters, sterol esters, fatty acids, primary and secondary alcohols, diols, ketones, aldehydes, aliphatic aldehydes, primary and secondary alcohols, β-diketones, triacylglycerols, and many more. Specific examples of plant wax include Carnauba wax, candelilla wax, ouricury wax, jojoba plant wax, bayberry wax, japan wax, sunflower wax, tall oil, tallow wax, rice wax, and tallows.

Animal wax includes beeswax as well as waxes secreted by other insects. A major component of the beeswax used in constructing honeycombs is the ester myricyl palmitate which is an ester of triacontanol and palmitic acid. Spermaceti occurs in large amounts in the head oil of the sperm whale. One of its main constituents is cetyl palmitate, another ester of a fatty acid and a fatty alcohol. Lanolin is a wax obtained from wool, consisting of esters of sterols. Other animal wax examples include lanocerin, shellac, and ozokerite.

Examples of mineral waxes include montan wax, paraffin wax, microcrystalline wax and intermediate wax. Although many natural waxes contain esters, paraffin waxes are hydrocarbons, mixtures of alkanes usually in a homologous series of chain lengths. Paraffin waxes are mixtures of saturated n- and iso-alkanes, naphthenes, and alkyl- and naphthene-substituted aromatic compounds. The degree of branching has an important influence on the properties. Montan wax is a fossilized wax extracted from coal and lignite. It is very hard, reflecting the high concentration of saturated fatty acids/esters and alcohols. Montan wax includes chemical components formed of long chain alkyl acids and alkyl esters having chain lengths of about 24 to 30 carbons. In addition, natural montan includes resin acids, polyterpenes and some alcohol, ketone and other hydrocarbons such that it is not a “pure” wax. The saponification number of montan, which is a saponifiable wax, is about 92 and its melting point is about 80° C. In addition to montan wax, other naturally derived waxes are known for use in various industries and include petroleum waxes derived from crude oil after processing, which include macrocrystalline wax, microcrystalline wax, petrolatum and paraffin wax. Paraffin wax is also a natural wax derived from petroleum and formed principally of straight-chain alkanes having average chain lengths of 20-30 carbon atoms.

Synthetic waxes include waxes based on polypropylene, polyethylene, and polytetrafluoroethylene. Other synthetic waxes are based on fatty acid amines, Fischer Tropsch, and polyamides. Polyethylene and related derivatives. Some waxes are obtained by cracking polyethylene at 400° C. The products have the formula (CH₂)ₙH₂, where n ranges between about 50 and 100.

Also known synthetic waxes which include synthetic polyethylene wax of low molecular weight, i.e., molecular weights of less than about 10,000, and polyethylenes that have wax-like properties. Such waxes can be formed by direct polymerization of ethylene under conditions suitable to control molecular weight. Polyethylenes with molecular weights in about the 2,000-4,000 range are waxes, and when in the range of about 4,000-12,000 become wax resins.

Fischer-Tropsch waxes are polymethylene waxes produced by a particular polymerization synthesis, specifically, a Fischer-Tropsch synthesis (polymerization of carbon monoxide under high pressure, high temperature and special catalysts to produce hydrocarbon, followed by distillation to separate the products into liquid fuels and waxes). Such waxes (hydrocarbon waxes of microcrystalline, polyethylene and polymethylene types) can be chemically modified by, e.g., air oxidation (to give an acid number of 30 or less and a saponification number no lower than 25) or modified with maleic anhydride or carboxylic acid. Such modified waxes are more easily emulsified in water and can be saponified or esterified. Other known synthetic waxes are polymerized alpha-olefins. These are waxes formed of higher alpha-olefins of 20 or more carbon atoms that have wax like properties. The materials are very branched with broad molecular weight distributions and melting points ranging about 54° C. to 75° C. with molecular weights of about 2,600 to 2,800. Thus, waxes differ depending on the nature of the base material as well as the polymerization or synthesis process, and resulting chemical structure, including the use and type of any chemical modification.

The matrix particles can be made either by polymerization or physical material breakdown, emulsion, dispersion, and/or suspension polymerization, core-shell polymerization, solvent dispersion, cavitation of fluids and/or solids in fluids, amalgamation of susceptors and catalysts, amalgamation followed by pulverizing, grinding and like processes.

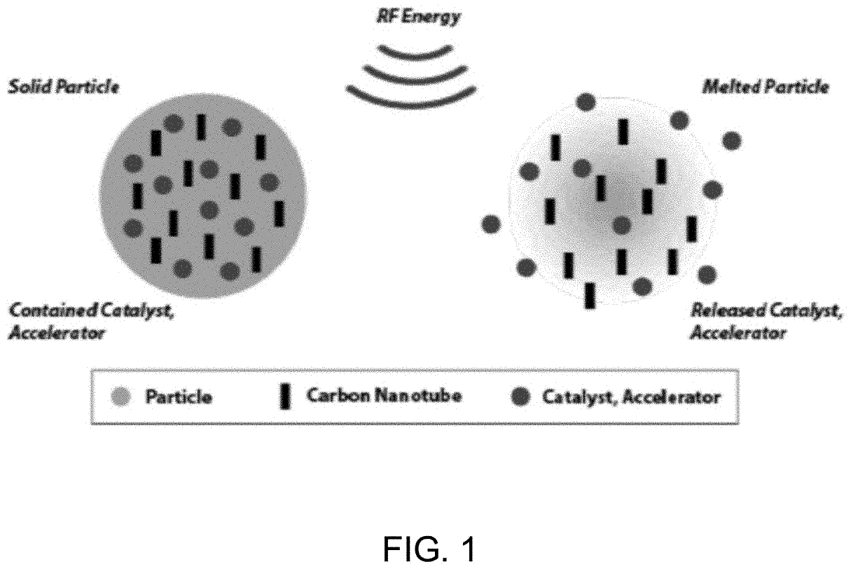

As shown in FIG. 1, a solid matrix particle is shown that comprises carbon nanotubes as susceptor component and a catalyst for accelerating the chemical reaction. Radio frequency is impinged on the matrix particle which heats up the carbon nanotube particles. These particles are embedded in proximity of the catalyst particles. The matrix material is melted or deformed, fully or partially, but as a result of the radio frequency, the catalyst is released which then catalyzes the reaction of the substance in with a plurality of matrix particles are incorporated.

In this embodiment, the RF or MW energy only heats and melts the matrix particles. The rate of heating of the matrix particle is many orders higher than the adjacent materials. The differential heating the matrix particles leads to the deformation of the matrix particles without causing the bulk heating. Furthermore, uniformly dispersed matrix particles and the size of particles leads to no appreciable heating of the adjacent formulations. As a result, the RF or MW energy activates the release of the contents of the matrix particles to induce polymerization uniformly and quickly. In one embodiment, it requires 2% or less of catalyst, typically in the ppm range. In one embodiment, the catalyst percent is any number selected from the numbers provided below, or is within a range defined by any two numbers below, including the endpoints of such range:

0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

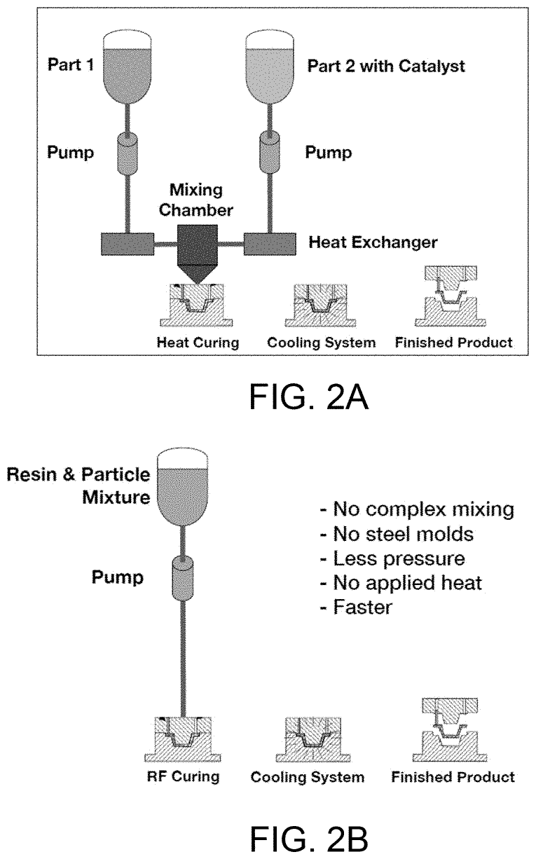

FIG. 2 shows reaction injection molding as currently practiced and with the invention. As a result of the invention, no complex mixing is required. Instead of heat curing, RF curing is done. This eliminates or reduces the use of steel molds; the reaction can be accomplished under lower pressure without application of gross heat and is faster. It also significantly reduces cure times.

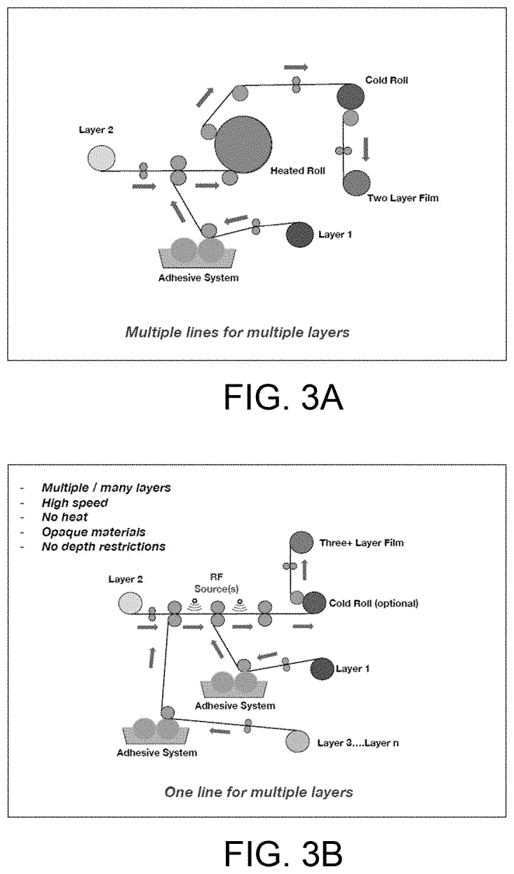

As shown in FIG. 3, as currently practiced, for film laminating adhesives, multiple film lines are used for multiple layers. With the use of the current invention, one line can be used for multiple layers. The advantage is high speed, no heat, opaque materials can be cured, and there are no depth restrictions. Control of curing location is also achieved, in addition to acute control of when in production curing is performed.

In one embodiment, the RF or MW is a directed source, in that the radiation is focused on a particular object or region of interest.

In some embodiments, the matrix may have a coating. In some embodiments, the coating is continuous. In some embodiments, the coating is discontinuous. In some embodiments, the coating is patterned. In some embodiments, the coating is deposited in one or more layers. In some embodiments, the coating is anisotropic.

In some embodiments, the coating attaches to the matrix by one or more means including, for example, entanglement, van der Waals interactions, through one or more chemically-bound compounds, and the like. In some embodiments, the coating includes one or more of a wax, one or more hydrophobic compounds and/or hydrophobic functional groups, one or more compounds having a nonpolar component including a nonpolar tail, including one or more oils, fatty acids, and the like.

The coating may have a thickness of up to 10 nm, from about 10 nm to about 15 nm, from about 50 nm to about 100 nm, from about 100 nm to about 500 nm, from about 500 nm to about 1 μm, from about 1 μm to about 2 μm, from about 2 μm to about 5 μm, from about 5 μm to about 10 μm, from about 10 μm to about 50 μm, from about 50 μm to about 100 μm, from about 100 μm to about 500 μm, from about 500 μm to about 1 mm, from about 1 mm to about 2 mm, from about 2 mm to about 5 mm , from about 5 mm to about 10 mm, from about 10 mm to about 50 mm, from about 50 mm to about 100 mm, from about 100 mm to about 500 mm, and any and all increments therebetween.

Embodiments of the matrix may include one or more additional components for providing controlled on-demand release. For example, matrices and or a coating and or a discontinuous coating containing matrices, coated or not, on any surface facile for matrix activation, such as round fibers, textile fibers, polymeric fibers, hollow fibers, reinforcing fiber such as that utilized in composites, sheets, flexible or inflexible materials, foams and other porous structures, non-woven materials, woven materials, polymer scrims, reinforcement scrims, and the like.

In some embodiments, the matrix includes one or more fillers. Embodiments of the fillers include particles such as fibers. The fibers may have one or more lengths. The fibers can include milled fibers. Embodiments of the fillers include one or more of clays, aggregates, plasticizers, plastic particles, nanoparticles of different shapes and the like.

### Particle Activation Process and Equipment

Particle activation, process and equipment constitutes a complete “System,” including various types of susceptors, activators, matrix components, RF and/or MW energy source(s), material handling, software, and controls.

Speed, time, unit throughput, form factor, topology, and unit volume are among the dependent characteristics that are analyzed for each application and adjusted by the Systems to produce a desired end artifact or result for a given set of materials.

Susceptors are excited via external high-frequency EMR to deform, in part or whole, the surrounding matrix or matrices to release the catalyst, co-catalyst, co-reactant, or accelerator. In areas such as remote joule heating properties of CNTs, without being bound to theory of the physical properties of how the CNTs heat the surrounding materials, the heated CNTs are used to deform the surrounding matrix.

In the most common form, microwave electromagnetic radiation with wavelengths ranging from about one meter to one millimeter; with frequencies between 300 MHz (1 m) and 300 GHz (1 mm) are used to excite the susceptors and deform the surrounding matrix to release the catalyst or activator material. In practice, various electromagnetic wavelengths and frequencies can be used; preferably the currently most common for consumer and industrial applications are frequencies of 915 MHz and 2450 Mhz. However, the one or more suitable frequencies may include up to about 100 MHz, from about 100 MHz to about 200 MHz, from about 200 MHz to about 400 MHz, from about 400 MHz to about 600 MHz, from about 600 MHz to about 800 MHz, from about 800 MHZ to about 1 GHz, from about 1 GZ to about 1.5 GHz, from about 1.5 GHz to about 2 GHz, from about 2 GHz to about 2.5 GHz, from about 2.5 GHz to about 5 GHz, from about 5 GHz to about 7.5 GHz, and any and all increments therebetween.

TABLE 1
Radiation Frequencies and Wavelengths

| Microwave Frequency | Wavelength |
|---|---|
| 245 MHz ± 0.2% | 122.19 cm |
| 433.92 MHz ± 0.2% | 69.14 cm |
| 580 MHZ ± 0.2% | 51.61 cm |
| 915 MHz ± 13 MHz | 32.75 cm |
| 2.45 GHz ± 50 MHz | 12.24 cm |
| 5.8 GHz ± 75 MHz | 5.17 cm |
| 24.125 GHz ± 125 MHz | 1.24 cm |

In one embodiment of the invention, the process of applying electromagnetic radiation, that is, impinging the bulk reaction mixture is performed for 10 seconds to 60 minutes. In another embodiment, the time of radiation is any one number selected from the following, in seconds, or a number within a range defined by any two numbers below, including the endpoints of such range, in seconds:

10, 15, 20, 25, 30, 35, 40, 45, 50, 55, 60, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, and 3600.

In one embodiment of the invention, the EMR is used as a beam to be impinged upon the bulk reaction mixture, where the bulk reaction mixture is bathed in RF or MW radiation.

### Applications

Exemplary applications include but are not limited to the following:

### Adhesive Bonding

Releasing a catalyst, co-catalyst and or accelerator and the like on demand wherein the limitations of gross heating, multi-component mixing, long polymerization times and or the limits of depth, such as with light and or surface primer activated systems can be eliminated by dispersing as desired said ingredients within the polymerizable composition and activated on demand at a desired moment within the bonding or bond and or part preparation process. Benefits also include much more precise positioning without a reaction changing viscosity dynamics.

### Coating

Releasing a catalyst, co-catalyst and or accelerator and the like on demand wherein the limitations of gross heating, multi-component mixing, long polymerization times and or the limits of depth, such as with light and or surface primer activated systems can be eliminated by dispersing as desired said ingredients within the polymerizable composition and activated on demand at a desired moment within the coating or coating and or part preparation process. Benefits also include flow control before and without a reaction changing viscosity dynamics. Can overcome the limitations of UV curable systems such as incomplete cure in shadow areas and parts that have complex shapes. No limitation to curing, 3D and concave parts that have large appendages. Coating rates can be matched with the upstream and downstream processing-debottlenecking the manufacturing throughputs.

### Molding and Composites

Releasing a catalyst, co-catalyst and or accelerator and the like on demand wherein the limitations of gross heating, multi-component mixing, long polymerization times and or the limits of depth, such as with light and or surface primer activated systems can be eliminated by dispersing as desired said ingredients within the polymerizable composition and activated on demand at a desired moment within the molding or mold and or part preparation process. Parts can be filled with many materials. Parts could be as large or larger than 14 feet by 14 feet in cross section. In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

### EXPERIMENTAL EXAMPLES

### Example 1—Methylene Malonate Polymerization via Anionic Polymerization

### Composition

This embodiment relates to a curable composition containing matrix particle, comprising:
(a) a methylene malonate monomer,
(b) a stabilizer solution, and
(c) an activator,
   (i) wherein the activator comprises a cation at a level of 0.1-500 ppm; and
   (ii) wherein the activator is encapsulated in a thermally deformable and or thermally soluble matrix particle also containing an RF susceptor (e.g. a carbon nanostructure).

### Formulations

The formulations are made up as follows by weight %, with other variations added as desired:
1. a difunctional or greater methylene malonate monomer, oligomer, or resin at 20% to 70.0%;
2. a diethyl, dipropyl, dibenzyl, di-isobornyl or similar methylene malonate monomer, 20% to 70%; and
3. an acid stabilizer solution 0.1% to 0.7%.

To the above formulations, 50 to 5000-nanometer matrix particles comprising of 90% paraffin wax, or an olefinic polymer, or oligomeric wax or similar, 8% carbon nanotubes, and 2% activator such that the particles exhibit, in the final overall composition, 5 ppm of the activator cation.

### Matrix Studies

Overall, the activator ranges from 0.5 ppm to 500 ppm, which is accomplished by varying the concentration of either the matrix particles , from 0.5% to 10%, and the power levels to determine in the application itself the proper frequency, power level, and thus, the time required to activate said particles, and consequently, the polymerization.

### MF-Transparent Fillers

One can then adjust formulations as created above by using chemically neutral, optionally dry RF transparent fillers, for example, minerals such as calcium carbonate, glass or glass powders, polymer powders, wood or other organic powders, silicas, silicates, and ceramics. Where moisture is a challenge, combinations of transition metal accelerators could be used, in particular copper hexanoate and iron, specifically ferrocene.

### Curing, Substrates and Containers

As formulations vary, cure speed and thus exotherms of polymerization will vary. Accordingly, one should start by placing small amounts of a formulation such that a thin film fits between two glass slides, thus minimizing materials and still creating an anaerobic condition and allowing for viewing. In the next step, one can add spacers to make thick bonds. In the next step, one can move to narrow test tubes and or syringe bodies. Next, one can scale to larger test tubes and or syringe bodies. Next one can scale to small beakers. Larger volume material assemblies and or containers can be placed in oils and/or water to control thermal conduction of exotherms to avoid dangerous situations.

Essentially, RF transparent materials are desired for containment or part of the containment such that the RF energy required can be aptly transmitted.

### Example 2—Free Radical Polymerization via Anaerobic Polymerization

### Composition

This embodiment relates to a curable composition comprising:
(a) an acrylate and or methacrylate monomer,
(b) a hydroperoxide or perester initiator, and
(c) an activator,
   (i) wherein the activator comprises a source of copper ion at a level of 0.1-100 ppm copper;
   (ii) wherein the activator is encapsulated in a thermally deformable and or thermally soluble matrix particle also containing an RF susceptor.

### Formulations

Formulations were made up as follows by weight %, with other variations added as desired:
1. Triethylene glycol dimethacrylate, a urethane diacrylate, or an epoxy diacrylate 20% to 70.0%
2. Lauryl, ethyl, methyl, ethyl hexyl, cyclohexyl, isobornyl methacrylate, 20% to 70%
3. Cumene hydroperoxide 0.5% to 3.0%
4. Stabilizer solution* 0.3% to 0.7%
5. Saccharin 0.1% to 0.5%

To these formulations, the following are added: 50 to 5000-nanometer matrix particles comprising of 90% by weight of one or more of a paraffin wax, an olefinic polymer, an oligomeric wax, or a similar matrix; 8% carbon nanotubes; and 2% copper ethyl hexanoate activator. These components are added such that the particles exhibit 0.6 ppm copper in the final composition

Instead of the 2% copper, one can also add, 0.06% to the formulation of a 50% particle dispersion with 2% ferrocene in said particles.

### Matrix Studies:

The copper hexanoate concentration ranges from 0.6 ppm to 60 ppm, which was accomplished by varying the concentration of the matrix particles, the % of the compounds in the matrix particles from 0.5% to 10%, and the power levels to determine in the application itself the proper RF wavelength, power level and thus time required to activate said particles and thus polymerization.

### RF-Transparent Fillers

Formulations were adjusted as created above by using chemically neutral, optionally dry RF transparent fillers, such as many minerals such as calcium carbonate, glasses or glass powders, polymer powders, wood or other organic powders, silicas, silicates, ceramics and the like. Where moisture is a challenge combinations of transition metal accelerators were used, in particular copper hexanoate and iron, specifically ferrocene.

### Curing, Substrates and Containers

As formulations vary, cure speed and thus exotherms of polymerization will vary. Accordingly, first place small amounts of a formulation such that a thin film fits between two glass slides, thus minimizing materials and still creating an anaerobic condition and allowing for viewing. Next, add spacers to make thick bonds. Next, move to narrow test tubes and or syringe bodies. Next scale to larger test tubes and or syringe bodies. Next scale to small beakers. Larger volume material assemblies and or containers are placed in oils and or water to control thermal conduction of exotherms to avoid dangerous situations. Essentially, RF transparent materials are desired for containment or part of the containment such that the RF energy required can be aptly transmitted.

### Example 3—Processes for Using Commercial Microparticles as Cores

This study demonstrates the use of available microparticles as the core of a matrix particle to carry the activator to initiate curing in a one-part adhesive formulation. The main object of the study is to demonstrate the use commercial PMMA already on the micro/nanoscale particles as carriers for acrylic activation by attaching the copper activators to the surface of the core of the commercially available particle.

TABLE 2
Commercially Available Particles Tested

| PMMA Product Name** | Particle Size |
|---|---|
| MX-500ML | 0.8 μm to 30 μm; average particle size: 5 μm |
| MP-1441 | 0.15 μm to 0.4 μm; average particle size: |
| | 0.17 μm |
| XX-6666Z | average particle size 4.7 μm |
| MX-180TA | 0.8 μm to 30 μm; average particle 1.8 μm |

**The MX-500ML, MP-1441, MX-180TA were sourced from the company Soken, Japan, and the XX6666Z was sourced from Sekisuikasei, Japan.

The following formulations were prepared to evaluate conditions for preparing matrix particles using various commercially available PMMA particles as the core of the matrix particles.

Formulation 1—Commercial PMMA (MX-500ML) (2 g) was filter-washed first with a 10% (100 mL) sodium hydroxide solution and then with a 10% (10 mL) cupric chloride solution, rinsed with DI water, and dried.

Formulation 2—Commercial PMMA (MX-500ML) (2 g) was filter-washed first with a 10% (100 mL) sodium hydroxide solution and then with a 10% (10 mL) cupric chloride solution, rinsed with DI water, and dried.

Formulation 3—Commercial PMMA (MP-1441) (2 g) was filter-washed with a 10% (100 mL) sodium hydroxide solution and then with a 10% (10 mL) cupric chloride solution, rinsed with DI water, and dried.

Formulation 4—Commercial PMMA (XX-6666Z) (2 g) was filter-washed with a 10% (100 mL) sodium hydroxide solution and then with a 10% (10 mL) cupric chloride solution, rinsed with DI water, and dried.

Formulation 5—Commercial PMMA (MP-1441) (5 g) was ultrasonicated with copper(II) 2-ethylhexanoate (1 g) in isopropanol and filter-washed with additional isopropanol.

Formulation 6—Commercial PMMA (MX-180TA) (2 g) was ultrasonicated with cupric chloride (0.125 g) in isopropanol and filter-washed with additional isopropanol.

Formulation 7—Commercial PMMA (MX-180TA) (4 g) was ultrasonicated with copper(II) 2-ethylhexanoate (0.21 g) in isopropanol and filter-washed with additional isopropanol.

Formulation 8—Commercial PMMA (MX-180TA) (4 g) was ultrasonicated with cupric chloride (0.2 g) in isopropanol and vacuum-filtered.

### Example 4—Preparation of Particle Cores Through Emulsion Polymerization

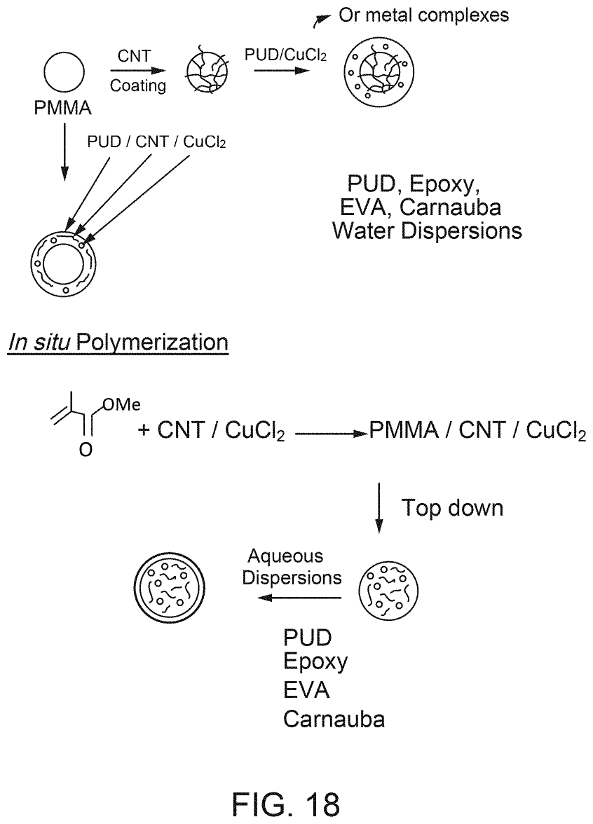

The main object of the study was to prepare nano-microparticle cores through emulsion polymerization, particularly through that of methacrylates. An exemplary reaction diagram is shown in FIG. 18. The formulations were prepared using an oil-in-water emulsion—of methacrylate in water—in order to emulsion polymerize into nanoparticles.

Experiment 1—At 70° C., methyl methacrylate (3 mL) was added to DI water (16 mL) to emulsify under inert gas. The polymerization reaction was catalyzed by ((2,2-azobis) 2-methyl-propionamidine) dihydrochloride (10-15 mg) and stirred for 30 minutes.

Experiment 2—At 70° C., methyl methacrylate (3 mL) was added to DI water (16 mL) to emulsify under inert gas. The polymerization reaction was catalyzed by ((2,2-azobis) 2-methyl-propionamidine) dihydrochloride (10-15 mg) and stirred for 40 minutes at 450 rpm.

Experiment 3—At 70° C., methyl methacrylate (3 mL) was added dropwise over 30-40 minutes to DI water (16 mL) to emulsify under inert gas. The polymerization reaction was catalyzed by ((2,2-azobis) 2-methyl-propionamidine) dihydrochloride (10-15 mg) and stirred for 40 minutes.

Experiment 4—Copper(II) 2-ethylhexanoate was dissolved in methyl methacrylate (3 mL) and injected into DI water (16 mL) under inert gas at 70° C. ((2,2-azobis) 2-methyl-propionamidine) dihydrochloride (10-15 mg) was added and stirred for 40 minutes at 350 rpm.

### Example 5—Process for the Preparation of Hollow Particle Cores

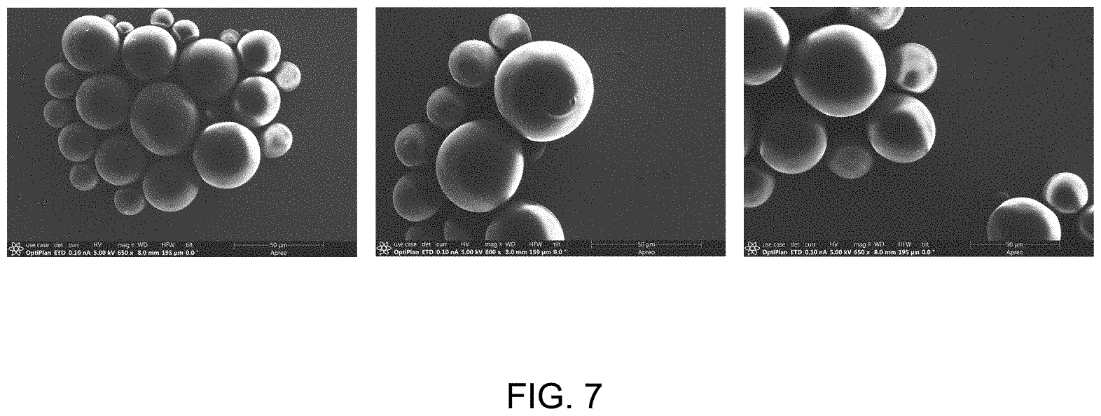

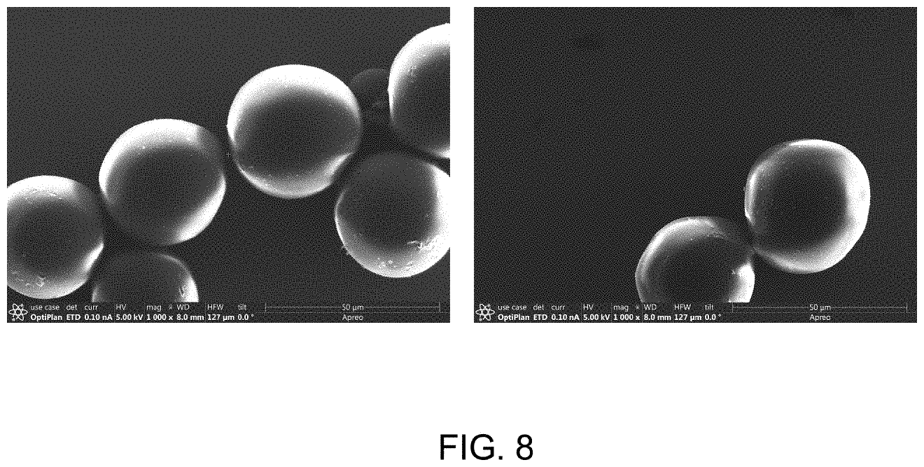

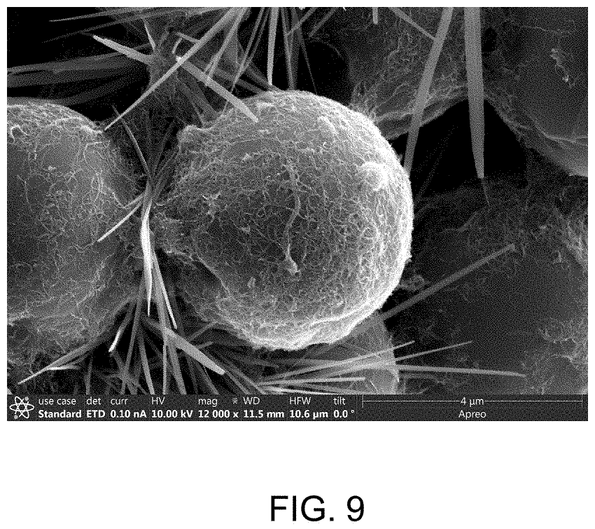

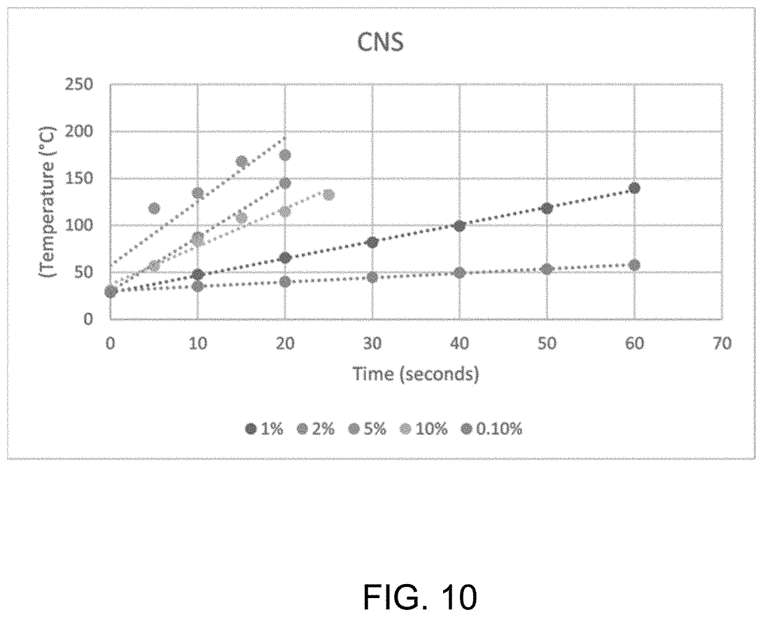

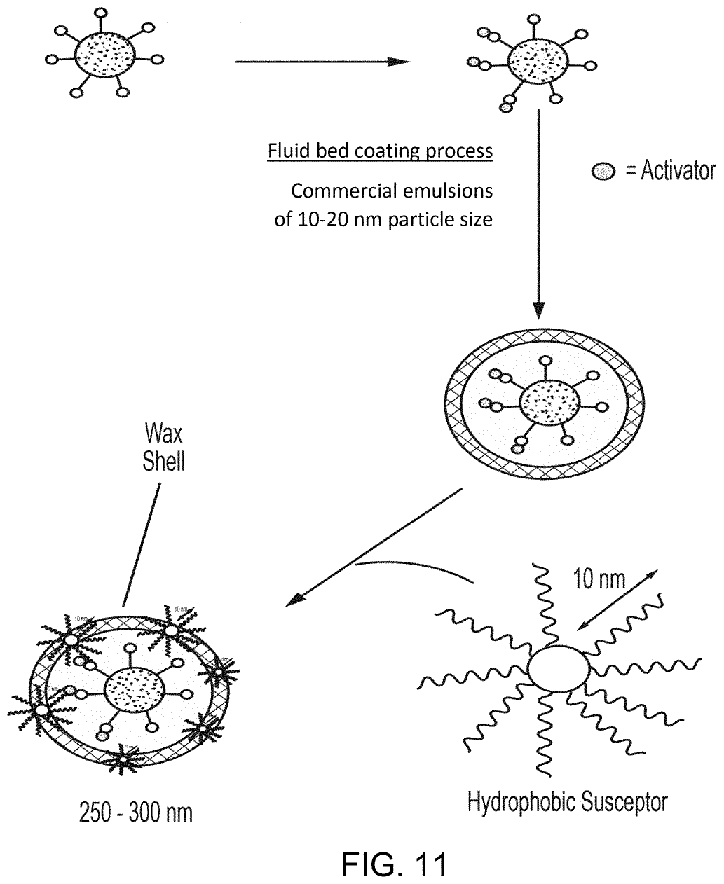

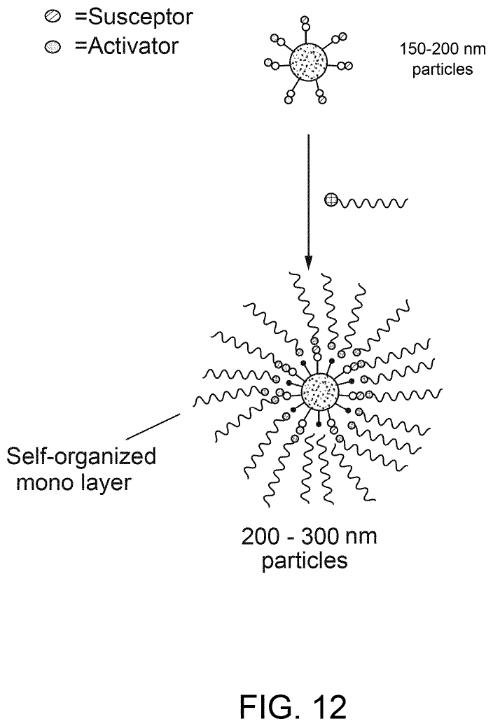

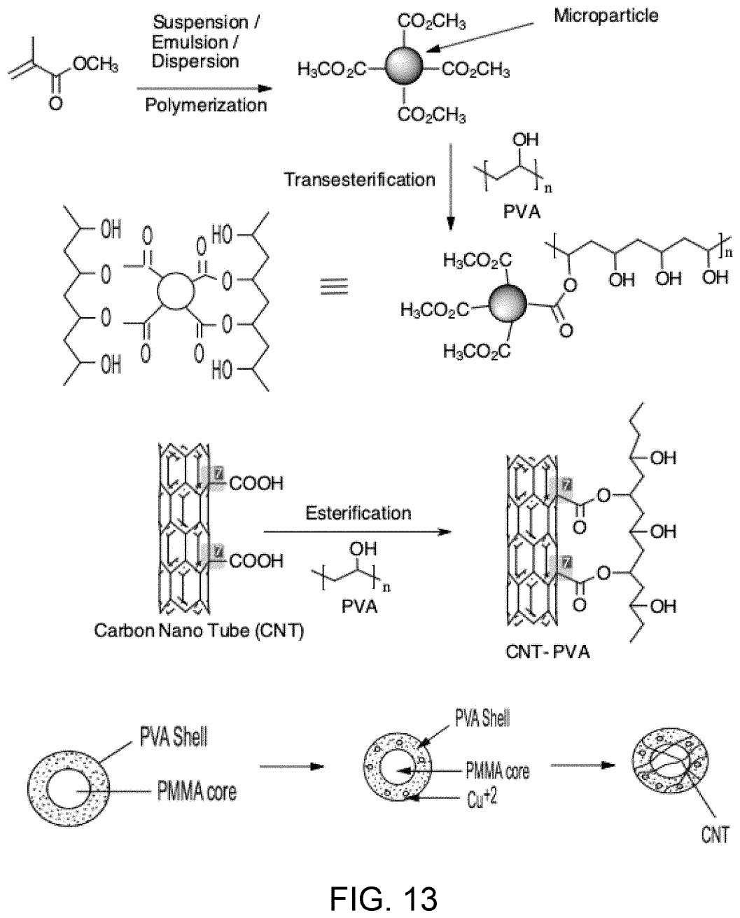

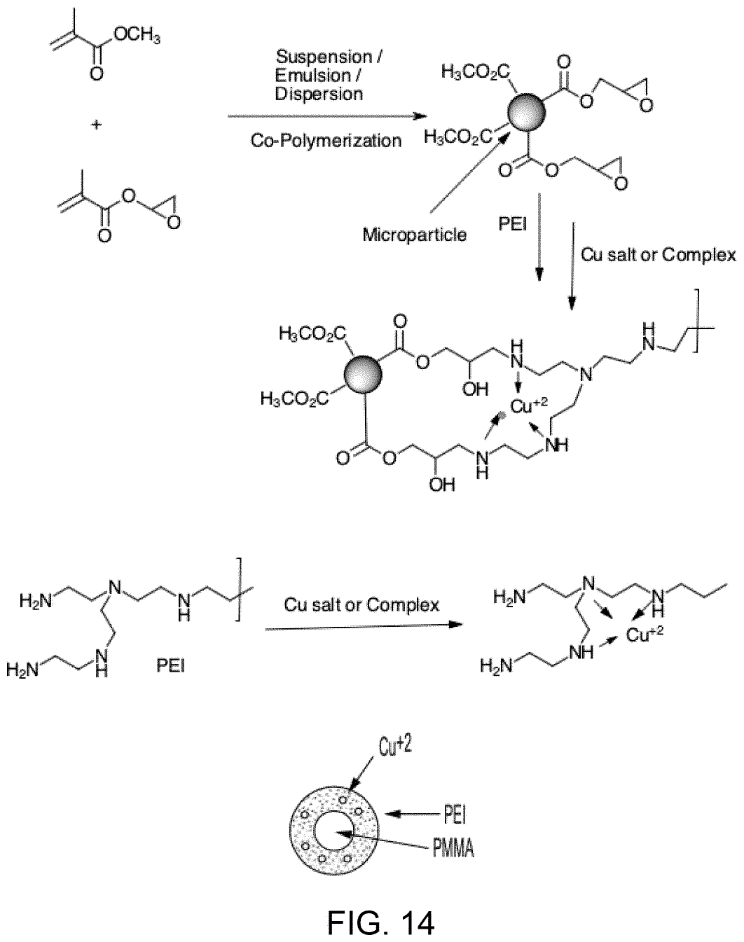

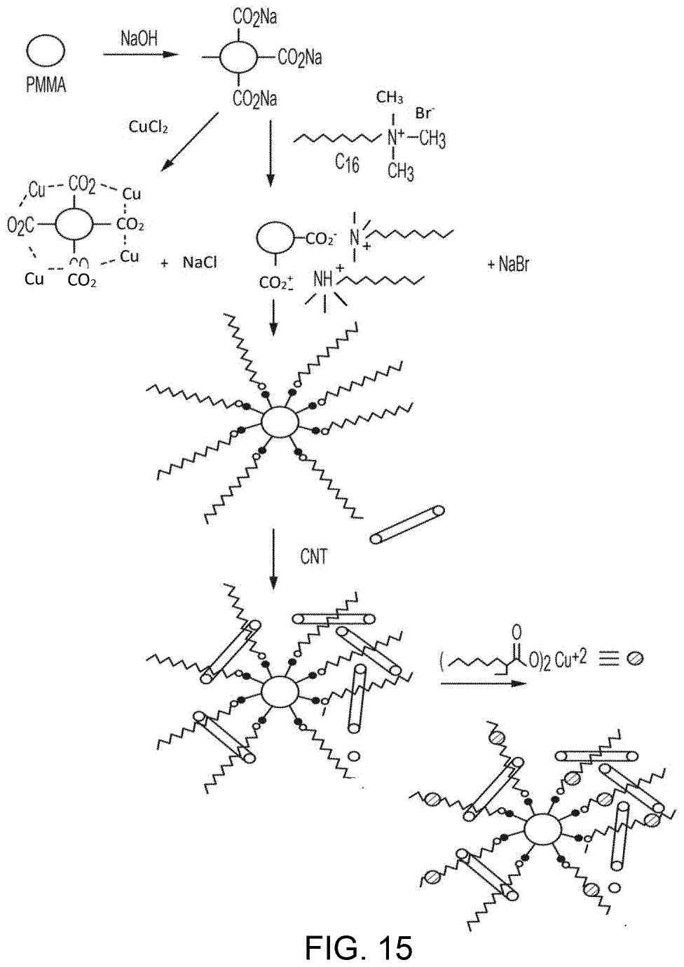

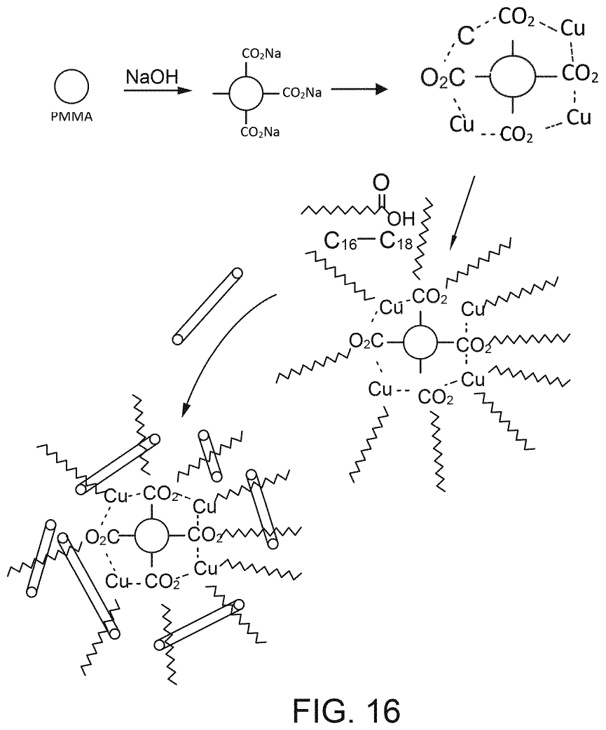

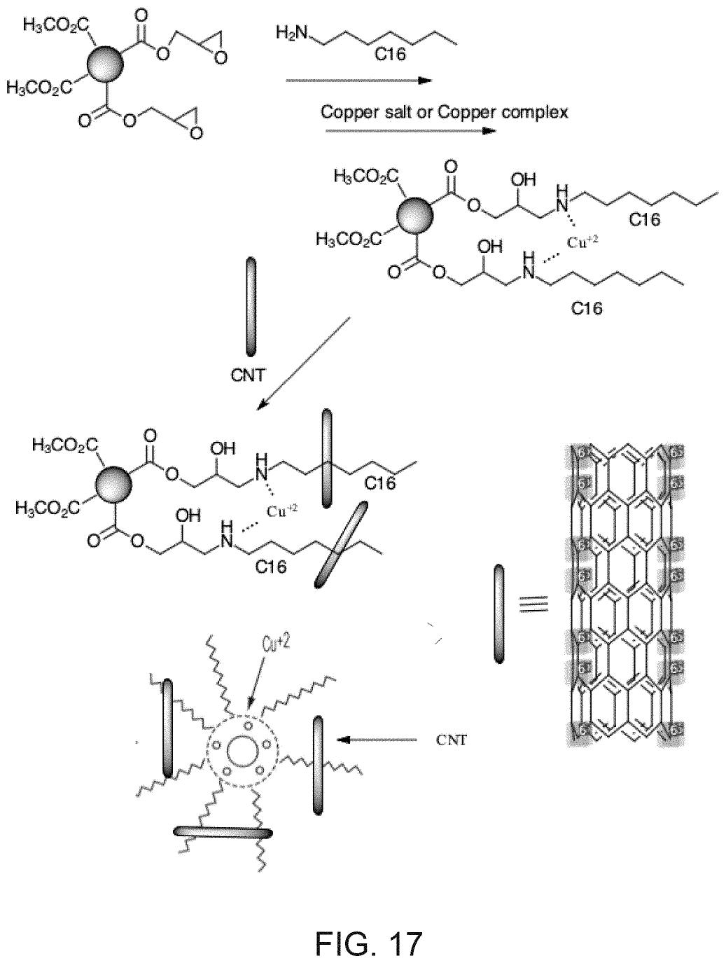

This study demonstrates methods for preparing hollow particle-core structures. Representative SEM images of hollow particles are shown in FIG. 7, while representative SEM images of hollow core particles combined with SPIONs and copper are shown in FIG. 8.

### Experiment 1

A solution of 5-6% w/v PMMA (120,000 g/mol) dissolved in dichloromethane (DCM) was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 2

A solution of 5-6% w/v PMMA (15,000 g/mol) dissolved in dichloromethane was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 3

A first solution of copper(II) 2-ethyl hexanoate (12.5 mg) dissolved in dichloromethane was prepared. A second solution of 5-6%w/v PMMA (15,000 g/mol) dissolved in the first solution was added dropwise to an aqueous medium of poly vinyl alcohol (0.5-0.6%w/v) and stirred at 500-550 rpm for 10-15 minutes. The final solution was left overnight or 12-18 hours until the DCM evaporated. The hollow particles were filter-washed three times with isopropanol and left to dry again.

### Experiment 4

A dispersion of SPIONs (12.5 mg) in dichloromethane was prepared. A 5-6% w/v PMMA (15,000 g/mol) dissolved in the SPION/dichloromethane dispersion was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 5

A dispersion of oleic acid-modified SPIONs (12.5 mg) in dichloromethane was prepared. A 5-6% w/v PMMA (15,000 g/mol) dissolved in the SPION/dichloromethane dispersion was added drop-wise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 6

A dispersion of oleic acid-modified SPIONs (12.5mg) and copper(II) 2-ethyl hexanoate (12.5 mg) in dichloromethane was prepared. A 5-6% w/v PMMA (15,000 g/mol) dissolved in the SPION/dichloromethane dispersion was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Example 6—Process for Preparing Cores by Amalgamation of Susceptors and Catalysts

This study demonstrates remotely activating microwave-susceptors within a matrix particle. The matrix used in these studies was prepared by combining susceptors and other components of the matrix particle as an amalgamation. The matrix particles were exposed to microwaves to release the activator to perform its function. For example, in some cases the microwaves heated the susceptor, carbon nanostructures, to release a copper catalyst from the matrix particles to catalyze a polymerization reaction.

### Experiment 1

Solution A was prepared by dissolving 5 g PMMA in xylenes at 80° C. for 20-30 minutes. Solution B was prepared by melting 5 g carnauba wax in xylenes with a heat gun. A and B were very slowly combined while continuously heating. Copper(II) 2-ethyl hexanoate (0.5%) was added to the solution of A and B. The solution was continuously stirred and heated 110° C. until most of the xylenes evaporated. Before all of it had evaporated 10% carbon nanostructures were added and high-sheer mixed. Once sufficient xylenes had evaporated to render the solution into a paste, the solution was crashed into ethanol. The solids were broken up with water in a blender and dried overnight to obtain powder. The powder was sieved through a micron mesh to obtain the core particles

### Experiment 2

A dispersion of 0.1 g carbon nanostructure pellets was made in 30 mL dichloromethane before adding a solution of 3 g hexadecyl trimethyl ammonium bromide (CTAB) dissolved in 10 mL isopropanol and 20 mL dichloromethane while mixing at 700 rpm. Copper(II) 2-ethyl hexanoate was added with 10 g solid plasticizer (Benzoflex™ 352) to the solution accompanied with continuous stirring. The sample was left out to stir until dry.

### Experiment 3

A mixture of 0.1 g carbon nanotubes was made with 0.2 g CTAB in 30 mL dichloromethane which was sonicated for 15 minutes at 30% power. An additional 50 mL of dichloromethane was added and the sample sonicated for an additional 15 minutes at 30%. A 9.9 g of Benzoflex™ 352 (solid plasticizer) and 1 g copper(II) 2-ethylhexanoate was added and hand mixed. A stir bar was added to the sample and left to stir on a hot plate at 35° C. and 700 rpm to maintain particle suspension while the dichloromethane evaporated.

### Experiment 4

A mixture of 0.11 g of Experiment 1 particles were dispersed in 10 mL dimethyl malonate by sonicating for 10 minutes. A single drop of these particles was tested by placing it on a glass microscope slide, microwaved for 60 seconds at 800 W/4V.

### Example 7—Process for Coating Microparticles with Susceptors

The present study demonstrates methods used for coating microparticles, for example, commercial PMMA microparticles with susceptors such as carbon nanotubes (CNT) or carbon nano-substances (CNS).

### Experiment 1

In this experiment, 250 mg of PMMA (Soken MX-500ML) was added to 50 ml of water. It was then sonicated for 30 minutes at 20% amplitude using a micro probe sonicator. In another flask, 300 mg of CNT was added to 120 ml of water. It was sonicated for 15 minutes at 10% amplitude using a probe sonicator. The dispersion of PMMA and water was taken into a beaker and stirred continuously at room temperature to avoid the settling of the PMMA particles. In the next, 10 ml of the dispersed CNTs in water was taken into a syringe and added dropwise using a syringe pump into the PMMA dispersion at 0.5 ml/min. The sample was left overnight to allow the coated PMMA particles to settle. The particles were then separated using a centrifuge.

### Experiment 2

In this experiment, 250 mg of PMMA (Soken MX-500ML) was added to 50 ml of water. It was then sonicated for 30 minutes at 20% amplitude using a micro probe sonicator. In another flask, 300 mg of CNS was added to 120 ml of water. It was sonicated for 15 minutes at 10% amplitude in the sonicator. The dispersion of PMMA and water was taken into a beaker and stirred continuously at room temperature to avoid the settling of the PMMA particles. Next, 10 ml of the dispersed CNTs in water was taken into a syringe and added dropwise using a syringe pump into the PMMA dispersion at 0.5 ml/min. The sample was left overnight to allow the coated PMMA particles to settle. The particles were the separated using a centrifuge.

### Experiment 3

In this experiment, 1 ml of PMMA that was made using the previously described emulsion polymerization method was added to 9 ml of water. In another flask, 300 mg of CNT was added to 120 ml of water. It was sonicated for 15 minutes at 10% amplitude using a micro probe sonicator. The dispersion of CNT and water was taken into a beaker and stirred continuously at room temperature. Next, 10 ml of the dispersed PMMA in water was taken into a syringe and added dropwise using a syringe pump into the CNT dispersion at 0.5 ml/min. The sample was left overnight to allow the coated PMMA particles to settle. The particles were then separated using a centrifuge.

### Example 8—Process for Preparation of Microparticles Through Emulsion Copolymerization

The present study provides methods for functionalizing the PMMA by copolymerizing the PMMA with various copolymers including poly (ethylene glycol) methacrylate (PEGMA), poly (ethylene glycol) dimethacrylate (PEGDMA), stearyl methacrylate, and methacrylic acid.

### Experiment 1

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 30-40 minutes. An additional 20 mg AIBN was added with 1.2 mL poly (ethylene glycol) methacrylate (PEGMA) and stirred for 40 minutes.

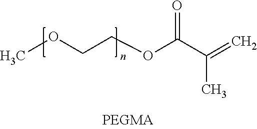

### Experiment 2

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 1.2 mL poly (ethylene glycol) methacrylate (PEGMA) and stirred for 40 minutes.

### Experiment 3

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 120 μL poly (ethylene glycol) methacrylate (PEGMA) and stirred for 40 minutes.

### Experiment 4

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 120 μL poly (ethylene glycol) dimethacrylate (PEGDMA) and stirred for 40 min.

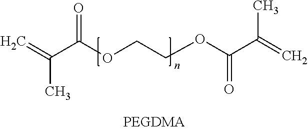

### Experiment 5

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 1.2 mL poly (ethylene glycol) dimethacrylate (PEGDMA) and stirred for 40 minutes.

### Experiment 6

A solution of sodium dodecyl sulfate (SDS) (0.5 g) dissolved in hydroxyethyl methacrylate (HEMA) (15 g) was prepared. This solution was transferred into a round-bottom flask of DI water (185 g) in a hot bath set to 70° C. and stirred at a high speed. The heat was turned off and while the solution continued to be stirred while AIBN (0.2 g) was being added.

### Experiment 7

A flask of 64 mL DI water was degassed and heated to 70° C. while stirring at 670 rpm for 20 minutes. In the next step, 1 g of stearyl methacrylate was dissolved into 9 mL methyl methacrylate. This solution was injected into the water dropwise over 15 minutes accompanied with constant stirring under the presence of inert gas. Once added, ((2,2-azobis) 2-methyl-propionamidine) dihydrochloride (AIBN) (40 mg) was added to the emulsion and the mixture/solution stirred for an additional hour.

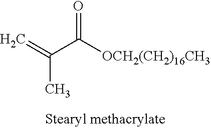

### Experiment 8

A flask containing 64mL DI water was degassed and heated to 70° C., with stirring of its contents at 670 rpm for 20 minutes. Then, separately, 5g of stearyl methacrylate was dissolved into 5 mL methyl methacrylate. This solution was injected into the flask dropwise over 15 minutes accompanied with constant stirring under the presence of inert gas. Once added, ((2,2-azobis) 2-methyl-propionamidine) dihydrochloride (AIBN) (40 mg) was added to the emulsion and stirred for an additional hour.

### Experiment 9

A flask of 64 mL DI water was degassed and heated to 70° C. with stirring of its contents at 670 rpm for 20 minutes. Next, 5 mL of methacrylic acid was dissolved into 5 mL methyl methacrylate. This solution was injected into the water dropwise over 15 minutes while constant stirring under inert gas. Once added, ((2,2-azobis) 2-methyl-propionamidine) dihydrochloride (AIBN) (40 mg) was added to the emulsion and stirred for an additional hour.

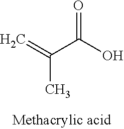

### Experiment 10

A flask of 64 mL DI water was degassed and heated to 70° C. with stirring of its contents at 670 rpm for 20 minutes. Next, 1 mL of methacrylic acid was mixed into 5 mL methyl methacrylate. This solution was injected into the water dropwise over 15 minutes while constant stirring under inert gas. Once added, ((2,2-azobis) 2-methyl-propionamidine) dihydrochloride (AIBN) (40 mg) was added to the emulsion and stirred for an additional hour.

### Experiment 11

At 70° C., methyl methacrylate (12 mL) was added dropwise to DI water (64 mL) to be emulsified under the presence of inert gas.. The polymerization reaction was catalyzed by ((2,2-azobis) 2-methyl-propionamidine) dihydrochloride (AIBN) (20 mg) and stirred for 5 minutes. An additional 500 μL of glycidyl methacrylate (GMA) was added and stirred for 40 minutes under inert gas.

### Experiment 12

At 70° C., glycidyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 40 minutes.

### Example 9—Process for Coating Commercially Available Microparticles with Commercial Emulsions

The objective of this study was to coat commercial PMMA particles as core with a shell that comprises susceptors and/or activators through a simple coating process.

### Experiment 1

In this experiment, 250 mg of PMMA (Soken MX-500ML) was added to 50 ml of water in a beaker. It was then sonicated for 30 minutes at 20% amplitude in a sonicator. At the same time, commercially manufactured SP-05032022-3: CNT dispersed in polyurethane, was diluted 100 times and added into another beaker. The dispersion of PMMA and water was stirred continuously at room temperature to avoid the settling of the PMMA particles. Then, 10 ml of the dispersed CNTs in polyurethane was added dropwise using a syringe pump into the PMMA dispersion at 0.5 ml/min. The sample was left overnight to allow the coated PMMA particles to settle. The particles were then separated using a centrifuge.

### Experiment 2

In this experiment, 250 mg of PMMA (Soken MX-500ML) was added to 50 ml of water in a beaker. It was then sonicated for 30 minutes at 20% amplitude in a sonicator. At the same time, commercially manufactured SP-05032022-05: Epoxy-CNT, was diluted 100 times and added into another beaker. The dispersion of PMMA and water was stirred continuously at room temperature to avoid the settling of the PMMA particles. Then, 10 ml of the diluted Epoxy-CNT was added dropwise using a syringe pump into the PMMA dispersion at 0.5 ml/min. The sample was left overnight in order for the coated PMMA particles to settle. The particles were then separated using a centrifuge.

### Experiment 3

In this experiment, 250 mg of PMMA (Soken MX-500ML) was added to 50 ml of water in a beaker. It was then sonicated for 30 minutes at 20% amplitude in a sonicator. At the same time, commercially manufactured SP-05032022-3: CNT dispersed in polyurethane, was diluted 10 times and added into another beaker. The dispersion of PMMA and water was stirred continuously at room temperature to avoid the settling of the PMMA particles. Then, 10 ml of the dispersed CNTs in polyurethane was added dropwise using a syringe pump into the PMMA dispersion at 0.5 ml/min. The sample was left overnight to allow for the coated PMMA particles to settle. The particles were then separated using a centrifuge.

### Example 10—Process for Using Carbon Nanostructures as Susceptors

This study demonstrates the use of commercial carbon nanostructures as radiofrequency (RF) radiation susceptors within a matrix particle to assist in the release of a catalyst to perform the catalyst's function of initiating a polymerization reaction. For example, the heating of the susceptor causes the matrix of the particle to melt which releases a chemical ingredient like a copper salt catalyst to initiate the polymerization. The objective of this study was to use commercial PMMA particles as carriers for a copper activator.

The particles generated in the experiments of the present study were prepared using commercial particles, with diameters on the micro to nanoscale, as carriers for acrylic activators by attaching the activator to the surface of the core of the matrix particle.

Microparticles from Examples 6, supra, were used for the following heating time course measurements.

### Experiment 1

Microparticles from Example 6 were taken and put in acrylic monomer formulations as 0.10 g in 3 g of monomer consisting of 3 parts triacrylated monomer (OTA 480): 1 part multifunctional acrylic monomer (EBECRYL® 896): 1 part polyurethane-acrylate (EBECRYL® 8811) all from Allnex Co and 5000 ppm of 4-methoxyphenol (MEHQ), 2% cumyl hydroperoxide (CHP) and 2% 4,N,N-trimethylaniline (DMPT). Data from heating experiments are shown in Table 4 below.

TABLE 3
Heating Time course Data

| | Temp | Temp | Temp | Average Temp |
|---|---|---|---|---|
| Time (s) | (° C.) | (° C.) | (° C.) | (° C.) |
| 0 | 30 | 33 | 30 | 31 |
| 10 | 59 | 62 | 60 | 60 |
| 20 | 109 | 113 | 101 | 10 |
| 30 | 171 | 178 | 158 | 169 |

### Example No. 11—Assessment of Stability of Particle Cores Prepared Using CNS Susceptors

Studies Performed with Foam

Foam cure tests were performed by cutting two pieces of foam into 4″ by 4″ cubes. The sample from Experiment 6 of Example 9, supra, being tested was pipetted onto one piece of foam so that it evenly covered one side of the cube, the layers were sufficiently thick to stick up above the pores of the foam. The second cube was placed on top of the first, completely covering the sample. The foam cubes were placed between two slides with a spacer and uniform pressure was maintained by clamping the glass slides using rubber bands. The clamped sample was placed in a microwave chamber under the thermal camera. To isolate the samples from direct heating, the samples were placed over the insulator in the microwave chamber. The samples were microwaved at 800 W power for preset amounts of time. After the sample was taken out of the microwave, the setup was carefully disassembled. To test if the foam has been glued together, the corners of the foam were gently pulled apart.

### Foam Types Tested:

A ½ inch Airtex high density foam used to make camper cushions, boat seating, chair pads, garden benches and small foam cushions.

A ⅛ inch divinylmat and ½ inch vinyl foam frequently used as structural core material for composite laminates, delivering added strength, stiffness, and insulation, without adding weight. Generally, the foams, readily conform to shapes, and can be bonded in layers to add thickness.

Nomex honeycomb made from aramid fiber, honeycomb exhibits outstanding flammability properties.

Studies Performed with Composite

Silicone molds in the shape of a bear were used to evaluate curing of bulk composites. One bear mold 5 cc volume was filled at a time and placed in the center of the microwave under the thermal camera. Only one sample was put in at a time to ensure the samples were under the field of view of the thermal camera. The bear mold was microwaved at 800 W power for preset amounts of time and taken out of the microwave to test for changes in viscosity or if a cure has occurred.

### Samples Tested

1. Sample A: Acrylic adhesive formula (See Experiment 1 in Example 9, above for formulation details) with no activator
2. Sample B: Acrylic adhesive formula+copper activator
3. Sample C: Acrylic adhesive formula+matrix particles (containing both susceptor and copper activator)
   Results from Experiments Performed at Room Temp with Airtex Foam:
1. Sample A: Did not cure after one month; this sample has no activator
2. Sample B: Cured in 30 minutes
3. Sample C: Cured within 30 second in the microwave, but at room temperature, it did not cure even after one month.
   Results from Experiments Performed at Room Temperature with Divinylmat, Vinyl Foam, and Honeycomb:
1. Sample A: Did not cure after one month; this sample has no activator in it.
2. Sample B: Cured in 30 minutes
3. Sample C: Cured within 30 seconds in the microwave, but at room temperature it did not cure even after one month.
   Results from Experiments Performed with Composite:
1. Sample A: Did not cure after one month; this sample has no activator in it.
2. Sample B: Cured in 30 minutes.
3. Sample C: Cured within 20 seconds in the microwave, but at room temperature it did not cure even after one month.

This experimentally shows the shelf life of the inventions matrix particles while still providing curing on-demand.

1. A matrix particle, comprising:
(i) at least one matrix material, wherein said matrix is capable of fully or partially altering its physical characteristics;
(ii) at least one susceptor component, wherein said at least one susceptor component is embedded in said at least one matrix material, and wherein said at least one susceptor component is capable of thermal activation through electromagnetic radiation; and
(iii) at least one releasable and/or activatable ingredient embedded in said at least one matrix material and in proximity to said susceptor component, wherein said at least one releasable and/or activatable ingredient is capable of impacting a chemical reaction.

2. The matrix particle as recited in claim 1, comprising one or more matrices that fit in discrete zones, said discrete zones being in one or more shape;
wherein the discrete zones comprise coatings or varied layers;
wherein each zone comprises from about zero to multiple susceptors and/or releasable ingredients; and
wherein the matrix particle, in the aggregate, has at least one zone comprising a susceptor and at least one zone containing a releasable ingredient.

3. The matrix particle as recited in claim 1, wherein said matrix is derived from and/or comprises organic, inorganic, monomeric, oligomeric, polymeric materials, or a combination thereof.

4. The matrix particle as recited in claim 1, wherein said at least one susceptor is selected from the group consisting of fullerene compounds, graphene, single-wall carbon nanotubes, multi-wall carbon nanotubes, carbon nanofibers, carbon nanotubes, doped carbon nanotubes, carbon sheets, one or more ferrous metals, oxides of one or more ferrous metals, SPIONS, one or more non-ferrous metals, oxides of one or more non-ferrous metals, transition metals, transition metal oxides, silicon carbide-based material, boron nitride, and one or more combinations thereof.

5. The matrix particle as recited in claim 4, wherein the dimensions of the susceptor are in the range of from about 0.1 nm to about 1000 μm.

6. The matrix particle as recited in claim 4, wherein the susceptors comprise functionalized susceptors, non-functionalized susceptors, or both functionalized and non-functionalized susceptors.

7. The matrix particle as recited in claim 1, wherein the susceptor is in the geometric center of a matrix material in direct or indirect contact with the susceptor.

8. The matrix particle as recited in claim 1, wherein the susceptor and/or the releasable ingredient are in an outer layer of the matrix particle, wherein the susceptor and the releasable ingredient are in direct or indirect contact.

9. The matrix particle as recited in claim 1 wherein the matrix particle is partially or wholly coated in one or more layers of a deformable material.

10. The matrix particle as recited in claim 1, where the matrix particle is are partially or wholly coated in one or more layers of a deformable material wherein one or more of said layers contains a susceptor and or a releasable ingredient.

11. The matrix particle as recited in claim 10, wherein the matrix material contains no susceptors or releasable ingredient.

12. The matrix particle as recited in claim 1, wherein said at least one releasable and/or activatable ingredient is a single chemical, a combination of chemicals, organic chemicals, and/or inorganic chemicals.

13. The matrix particle as recited in claim 1, wherein said chemical ingredient comprises one or more catalysts, co-catalysts, co-reactants, oxidizers, reaction-inhibiting compounds, accelerators, co-accelerators, fuels, an explosives, or one or more combinations thereof.

14. The matrix particle as recited in claim 1, wherein the releasable ingredient is released when the matrix is deformed, dissolved, melted, expanded, contracted, ruptured, plasticized, solvated, impacted by light, or one or more combinations thereof.

15. The matrix particle as recited in claim 1, wherein said matrix is optionally supported with a support comprising a metal, a ceramic, or a glass.

16. The matrix particle as recited in claim 1, wherein the particle is further chemically surface modified via one or more chemical reactions, optionally comprising a releasable ingredient, optionally then forming a partial or complete coating.

17. The matrix particle as recited in claim 1, possessing a chemical functionality.

18. The matrix particle as recited in claim 1, wherein the releasable ingredient comprises a chemically functional monomer, wherein the matrix material comprises a polymerized material, and optionally, the matrix particle is coated with a polymerized coating.

19. A process for preparing the matrix particle as recited in claim 1, the process steps comprising:
(i) emulsion, dispersion, and/or suspension polymerization, or
(ii) core-shell polymerization.

20. A process for preparing the matrix particle as recited in claim 1, the process comprising:
(i) coating a polymeric microparticle with a material comprising susceptors and releasable ingredients,
(ii) encapsulating a microparticle in which susceptors and releasable ingredients are embedded, with a monomeric, oligomeric, or a polymeric or a polymeric material, and/or
(iii) amalgamating the susceptors and releasable ingredients,
(iv) entrapping the susceptors and releasable ingredients into external pores on the surface or internal pores in the core of the porous microspheres.

21. A process for preparing the matrix particle as recited in claim 1, the process steps comprising copolymerization, wherein said copolymerization step comprises emulsion, dispersion, suspension polymerization or combinations thereof.

22. A process for impacting a chemical reaction, comprising:
(i) providing a bulk reaction mixture;
(ii) providing matrix particles as recited in claim 1; and
(iii) incorporating the matrix particles in the bulk reaction mixture.

23. The process as recited in claim 22, further comprising:
(iv) impinging the bulk reaction mixture with at least one frequency of RF radiation and/or at least one frequency of MW radiation, at least once, on to thermally activate said susceptor component embedded within the matrix particles.

24. The process as recited in claim 23, wherein the impinging of the at least one frequency of RF radiation and/or at least one frequency of MW radiation is performed periodically, wherein the period is regular or irregular.

25. The process as recited in claim 24, wherein the electromagnetic radiation comprises wavelengths ranging from about one meter to one millimeter; and frequencies ranging between 50 MHz and 30 GHz.

26. The process as recited in claim 25, wherein the electromagnetic radiation frequency is in the range of from about 915 MHz to about 2.450 MHz.

27. The process as recited in claim 25, wherein the electromagnetic radiation frequency is in the range of from about 915 MHz to about 2.450 MHz and/or the power is in the range of 1-10,000 W.

28. The process as recited in claim 25, wherein the electromagnetic radiation is impinged for 10 seconds to 60 minutes.

29. The process as recited in claim 25, wherein said reaction is a polymerization reaction.

30. A process for releasing a releasable ingredient from a matrix particle, as recited in claim 1, comprising:
(a) dispersing said matrix particles in a bulk reaction mixture; and
(b) impinging the bulk reaction mixture with at least one frequency of RF radiation and/or at least one frequency of MW radiation, at least once, on to thermally activate said susceptor component embedded within the matrix particles.

31. A bulk reaction mixture comprising the matrix particles as recited in claim 1.

32. The bulk reaction mixture as recited in claim 31, further comprising components that are not impacted by the RF and/or MW radiation.

33. The matrix particle of claim 1, wherein the one or more alterable matrix material comprises a wax, one or more of polymethyl methacrylate (PMMA), styrene, or one or more polymers or copolymers thereof.

34. The matrix particle of claim 1, wherein the at least one releasable chemical ingredient comprises an activator or catalyst.

35. The matrix particle of claim 1, wherein the catalyst comprises one or more of Cu-acetyl acetonate, Cu-2-ethyl hexanoate, ferrocene, dimethylaminomethyl ferrocene, or one or more combinations thereof.

36. An article prepared using the process of claim 25.

37. An article prepared as in claim 36 that is in whole or part:
(i) a polymerizable composition or several polymerizable compositions of at least one chemistry;
(ii) a reinforced composite article;
(iii) a laminated article;
(iv) a rigid laminated article;
(v) a flexible laminated article;
(vi) a foam; or a
(vii) combination thereof.

38. A composition comprising the matrix particle as recited in claim 1, wherein said composition is an adhesive, sealant, coating, paint, ink, plastic, molded plastic, thermoset plastic, molded thermoset plastic, or other polymer forming composition, in whole or part.

39. The matrix particle as recited in claim 1, wherein the releasable and/or activatable ingredient is a catalyst selected from the group consisting of transition metal complexes; transition metal alkoxides; stannous (II) bis(2-ethylhexanoate); carboxylates, alkoxide, and complexes of stannous, bismuth, zinc, titanium; blocked super acids; dodecyl benzene sulphonic acids; dinonyl naphthalene sulphonic acids; N,N′,N″-tris(dimethylaminopropyl) hexahydrotriazine; organic bases; 1,8-diazabicyclo [5.4.0] undec-7-ene; 1,5-diazabicyclo [4.3.0] nonene-5); (1,4-diazabicylo 2.2.2 octane); and combinations thereof.

40. A multilayer polymer composition comprising a first matrix particle according to claim 1, and one or more additional matrix particles according to claim 1, disposed upon the first matrix particle forming one or more matrix particle layers.
